(19) United States
(12) Patent Application Publication
(10) Pub. No.: US 2012/0050602 A1
(43) Pub. Date: Mar. 1, 2012

(54) Zoom Lens System, Interchangeable Lens Apparatus and Camera System

(75) Inventors: Takuya Imaoka, Kanagawa (JP); Kyoichi Miyazaki, Osaka (JP)

(73) Assignee: PANASONIC CORPORATION, Osaka (JP)

(21) Appl. No.: 13/215,255

(22) Filed: Aug. 23, 2011

(30) Foreign Application Priority Data
Aug. 24, 2010 (JP) 2010-187332

(51) Int. Cl. H04N 5/232; G02B 15/14

(52) U.S. Cl. 348/347; 359/683; 348/E05.045

(57) ABSTRACT

A zoom lens system comprising a plurality of lens units, each lens unit comprising at least one lens element, wherein a lens unit located closest to an object side has negative optical power, in zooming from a wide-angle limit to a telephoto limit at the time of image taking, the lens unit located closest to the object side and a lens unit located closest to an image side are fixed relative to an image surface, the lens unit located closest to the object side includes at least one lens element having positive optical power and at least one lens element having negative optical power, and an image blur compensating lens unit is provided, which moves in a direction perpendicular to an optical axis, in order to optically compensate image blur; an interchangeable lens apparatus; and a camera system are provided.

### CROSS-REFERENCE TO RELATED APPLICATION

This application is based on application No. 2010-187332 filed in Japan on Aug. 24, 2010, the contents of which are hereby incorporated by reference.

### BACKGROUND OF THE INVENTION

1. Field of the Invention

The present invention relates to a zoom lens system, an interchangeable lens apparatus, and a camera system. In particular, the present invention relates to: a compact and lightweight zoom lens system having a relatively high zooming ratio, less aberration fluctuation in association with focusing, excellent optical performance over the entire focusing condition with sufficiently compensated aberrations particularly in a close-object in-focus condition, and an excellent blur compensation function; and an interchangeable lens apparatus and a camera system each employing the zoom lens system.

2. Description of the Background Art

In recent years, interchangeable-lens type digital camera systems (also referred to simply as “camera systems”, hereinafter) have been spreading rapidly. Such interchangeable-lens type digital camera systems can realize: taking of a high-sensitive and high-quality image; high-speed focusing and high-speed image processing after image taking; and easy replacement of an interchangeable lens apparatus in accordance with a desired scene. Furthermore, an interchangeable lens apparatus having a zoom lens system that forms an optical image with variable magnification is popular because it allows free change of focal length without the necessity of lens replacement.

A compact zoom lens system having a high zooming ratio and excellent optical performance from a wide-angle limit to a telephoto limit has been desired as a zoom lens system to be used in an interchangeable lens apparatus. Various kinds of zoom lens systems having multiple-unit configurations, such as four-unit configuration and five-unit configuration, have been proposed. In such zoom lens systems, focusing can be performed such that some lens units in the lens system are moved in a direction along the optical axis.

For example, Japanese Patent No. 3054185 discloses a zoom lens having a six-unit configuration of positive, negative, positive, negative, positive, and positive. In this zoom lens, in zooming from a wide-angle limit to a middle position, magnification is varied using the fourth lens unit with the second lens unit being fixed on the object side, and the sixth lens unit is moved to perform focusing.

Japanese Laid-Open Patent Publication No. 10-111455 discloses a zoom lens having a five-unit configuration of positive, negative, positive, negative, and positive. In this zoom lens, the focal length at a wide-angle limit is shorter than the diagonal length of a screen. In zooming from a wide-angle limit to a telephoto limit, at least the fifth lens unit is moved to the object side to vary the intervals between the respective lens units. The second lens unit, or a whole or part of a vibration-proof lens unit for optically compensating image blur is moved in the optical axis direction to perform focusing.

Japanese Laid-Open Patent Publication No. 2007-279077 discloses a variable magnification optical system having at least four-unit configuration of negative, positive, negative, and positive. In this system, in zooming from a wide-angle limit to a telephoto limit, at least the second lens unit and the fourth lens unit are moved to decrease the interval between the first and second lens units, increase the interval between the second and third lens units, and decrease the interval between the third and fourth lens units. In the case of adopting, for example, a five-unit configuration or a six-unit configuration, the fifth lens unit is moved in the optical axis direction to perform focusing.

In each of the zoom lenses and the variable magnification optical system disclosed in the above-described patent literatures, since the amount of movement of the lens unit responsible for focusing is determined by the paraxial power configuration in the entire lens system, the amount of aberration fluctuation at the time of focusing is not sufficiently compensated from a wide-angle limit to a telephoto limit, and particularly, compensation of various aberrations in a close-object in-focus condition is insufficient. Therefore, none of the zoom lenses and the variable magnification optical system has excellent optical performance over the entire object distance from an infinite object distance to a close object distance. Further, each of the zoom lenses and the variable magnification optical system disclosed in the patent literatures cannot perform blur compensation, or does not have a blur compensation function that satisfies the recent requirements for zoom lens systems.

### SUMMARY OF THE INVENTION

An object of the present invention is to provide: a compact and lightweight zoom lens system having a relatively high zooming ratio, less aberration fluctuation in association with focusing, excellent optical performance over the entire focusing condition with sufficiently compensated aberrations particularly in a close-object in-focus condition, and an excellent blur compensation function; and an interchangeable lens apparatus and a camera system each employing the zoom lens system.

The novel concepts disclosed herein were achieved in order to solve the foregoing problems in the conventional art, and herein is disclosed:

a zoom lens system comprising a plurality of lens units, each lens unit comprising at least one lens element, wherein

a lens unit located closest to an object side has negative optical power,

in zooming from a wide-angle limit to a telephoto limit at the time of image taking, the lens unit located closest to the object side and a lens unit located closest to an image side are fixed relative to an image surface,

the lens unit located closest to the object side includes at least one lens element having positive optical power and at least one lens element having negative optical power, and

an image blur compensating lens unit is provided, which moves in a direction perpendicular to an optical axis in order to optically compensate image blur.

The novel concepts disclosed herein were achieved in order to solve the foregoing problems in the conventional art, and herein is disclosed:

an interchangeable lens apparatus comprising:

a zoom lens system; and

a lens mount section which is connectable to a camera body including an image sensor for receiving an optical image formed by the zoom lens system and converting the optical image into an electric image signal, wherein

the zoom lens system comprises a plurality of lens units, each lens unit comprising at least one lens element, in which

a lens unit located closest to an object side has negative optical power,

in zooming from a wide-angle limit to a telephoto limit at the time of image taking, the lens unit located closest to the object side and a lens unit located closest to an image side are fixed relative to an image surface,

the lens unit located closest to the object side includes at least one lens element having positive optical power and at least one lens element having negative optical power, and

an image blur compensating lens unit is provided, which moves in a direction perpendicular to an optical axis in order to optically compensate image blur.

The novel concepts disclosed herein were achieved in order to solve the foregoing problems in the conventional art, and herein is disclosed:

a camera system comprising:

an interchangeable lens apparatus including a zoom lens system; and

a camera body which is detachably connected to the interchangeable lens apparatus via a camera mount section, and includes an image sensor for receiving an optical image formed by the zoom lens system and converting the optical image into an electric image signal, wherein

the zoom lens system comprises a plurality of lens units, each lens unit comprising at least one lens element, in which

a lens unit located closest to an object side has negative optical power,

in zooming from a wide-angle limit to a telephoto limit at the time of image taking, the lens unit located closest to the object side and a lens unit located closest to an image side are fixed relative to an image surface,

the lens unit located closest to the object side includes at least one lens element having positive optical power and at least one lens element having negative optical power, and

an image blur compensating lens unit is provided, which moves in a direction perpendicular to an optical axis in order to optically compensate image blur.

According to the present invention, it is possible to provide: a compact and lightweight zoom lens system having a relatively high zooming ratio, less aberration fluctuation in association with focusing, excellent optical performance over the entire focusing condition with sufficiently compensated aberrations particularly in a close-object in-focus condition, and an excellent blur compensation function; and an interchangeable lens apparatus and a camera system each employing the zoom lens system.

### BRIEF DESCRIPTION OF THE DRAWINGS

This and other objects and features of this invention will become clear from the following description, taken in conjunction with the preferred embodiments with reference to the accompanied drawings in which:

FIG. 1 is a lens arrangement diagram showing an infinity in-focus condition of a zoom lens system according to Embodiment 1 (Example 1);

FIG. 2 is a longitudinal aberration diagram of an infinity in-focus condition of a zoom lens system according to Example 1;

FIG. 3 is a longitudinal aberration diagram of a close-object in-focus condition of a zoom lens system according to Example 1;

FIG. 4 is a lateral aberration diagram of a zoom lens system according to Example 1 at a telephoto limit in a basic state where image blur compensation is not performed and in an image blur compensation state;

FIG. 5 is a lens arrangement diagram showing an infinity in-focus condition of a zoom lens system according to Embodiment 2 (Example 2);

FIG. 6 is a longitudinal aberration diagram showing an infinity in-focus condition of a zoom lens system according to Example 2;

FIG. 7 is a longitudinal aberration diagram of a close-object in-focus condition of a zoom lens system according to Example 2;

FIG. 8 is a lateral aberration diagram of a zoom lens system according to Example 2 at a telephoto limit in a basic state where image blur compensation is not performed and in an image blur compensation state;

FIG. 9 is a lens arrangement diagram showing an infinity in-focus condition of a zoom lens system according to Embodiment 3 (Example 3);

FIG. 10 is a longitudinal aberration diagram showing an infinity in-focus condition of a zoom lens system according to Example 3;

FIG. 11 is a longitudinal aberration diagram of a close-object in-focus condition of a zoom lens system according to Example 3;

FIG. 12 is a lateral aberration diagram of a zoom lens system according to Example 3 at a telephoto limit in a basic state where image blur compensation is not performed and in an image blur compensation state;

FIG. 13 is a lens arrangement diagram showing an infinity in-focus condition of a zoom lens system according to Embodiment 4 (Example 4);

FIG. 14 is a longitudinal aberration diagram showing an infinity in-focus condition of a zoom lens system according to Example 4;

FIG. 15 is a longitudinal aberration diagram of a close-object in-focus condition of a zoom lens system according to Example 4;

FIG. 16 is a lateral aberration diagram of a zoom lens system according to Example 4 at a telephoto limit in a basic state where image blur compensation is not performed and in an image blur compensation state;

FIG. 17 is a lens arrangement diagram showing an infinity in-focus condition of a zoom lens system according to Embodiment 5 (Example 5);

FIG. 18 is a longitudinal aberration diagram showing an infinity in-focus condition of a zoom lens system according to Example 5;

FIG. 19 is a longitudinal aberration diagram of a close-object in-focus condition of a zoom lens system according to Example 5;

FIG. 20 is a lateral aberration diagram of a zoom lens system according to Example 5 at a telephoto limit in a basic state where image blur compensation is not performed and in an image blur compensation state;

FIG. 21 is a lens arrangement diagram showing an infinity in-focus condition of a zoom lens system according to Embodiment 6 (Example 6);

FIG. 22 is a longitudinal aberration diagram showing an infinity in-focus condition of a zoom lens system according to Example 6;

FIG. 23 is a longitudinal aberration diagram of a close-object in-focus condition of a zoom lens system according to Example 6;

FIG. 24 is a lateral aberration diagram of a zoom lens system according to Example 6 at a telephoto limit in a basic state where image blur compensation is not performed and in an image blur compensation state; and

FIG. 25 is a schematic construction diagram of an interchangeable-lens type digital camera system according to Embodiment 7.

### DESCRIPTION OF THE PREFERRED EMBODIMENTS

### Embodiments 1 to 6

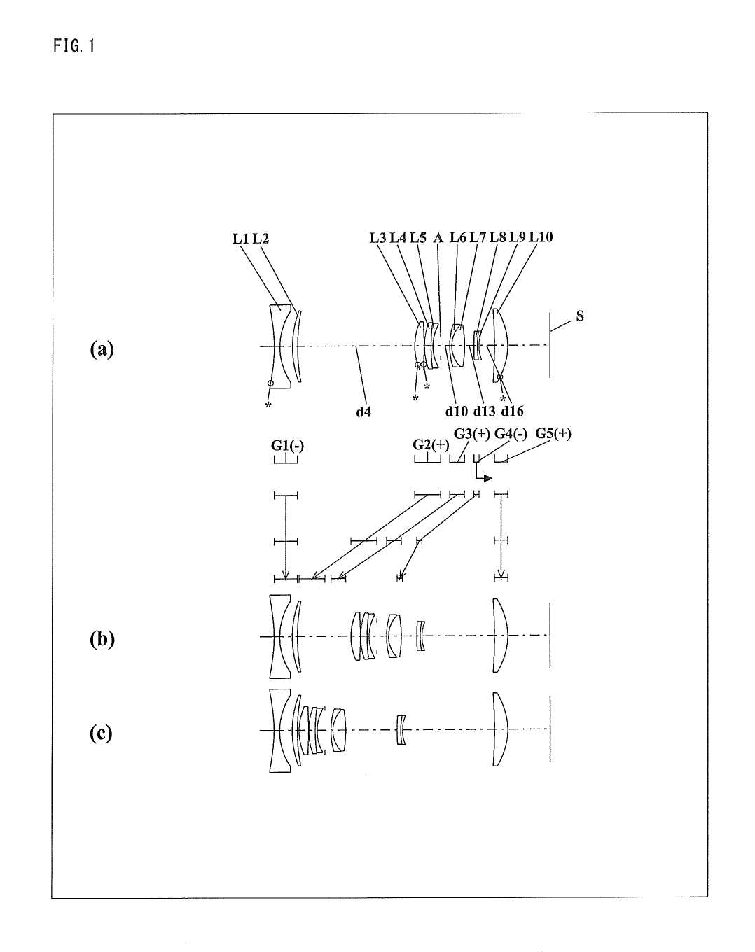

FIGS. 1, 5, 9, 13, 17, and 21 are lens arrangement diagrams of zoom lens systems according to Embodiments 1 to 6, respectively. Each Fig. shows a zoom lens system in an infinity in-focus condition.

In each Fig., part (a) shows a lens configuration at a wide-angle limit (in the minimum focal length condition: focal length f_{W}), part (b) shows a lens configuration at a middle position (in an intermediate focal length condition: focal length f_{M}=√(f_{W}*f_{T})), and part (c) shows a lens configuration at a telephoto limit (in the maximum focal length condition: focal length f_{T}). Further, in each Fig., each bent arrow located between part (a) and part (b) indicates a line obtained by connecting the positions of each lens unit respectively at a wide-angle limit, a middle position and a telephoto limit, in order from the top. In the part between the wide-angle limit and the middle position, and the part between the middle position and the telephoto limit, the positions are connected simply with a straight line, and hence this line does not indicate actual motion of each lens unit.

Moreover, in each Fig., an arrow imparted to a lens unit indicates focusing from an infinity in-focus condition to a close-object in-focus condition. That is, in FIGS. 1, 5, 9, 13, 17, and 21, the arrow indicates the moving direction of a fourth lens unit G4, which is described later, at the time of focusing from an infinity in-focus condition to a close-object in-focus condition. In FIGS. 1, 5, 9, 13, 17, and 21, since the symbols of the respective lens units are imparted to part (a), the arrow indicating focusing is placed beneath each symbol of each lens unit for the convenience sake. However, the direction along which each lens unit moves at the time of focusing in each zooming condition will be hereinafter described in detail for each embodiment.

Each of the zoom lens systems according to Embodiments 1 to 6, in order from the object side to the image side, comprises: a first lens unit G1 having negative optical power; a second lens unit G2 having positive optical power; a third lens unit G3 having positive optical power; a fourth lens unit G4 having negative optical power; and a fifth lens unit G5 having positive optical power. In the zoom lens systems according to Embodiments 1 to 6, at the time of zooming, the second lens unit G2, the third lens unit G3, and the fourth lens unit G4 individually move in the direction along the optical axis so that the intervals between the respective lens units, i.e., the interval between the first lens unit G1 and the second lens unit G2, the interval between the second lens unit G2 and the third lens unit G3, the interval between the third lens unit G3 and the fourth lens unit G4, and the interval between the fourth lens unit G4 and the fifth lens unit G5 vary. In the zoom lens systems according to Embodiments 1 to 6, these lens units are arranged in a desired optical power configuration, and thereby size reduction is achieved in the entire lens system while maintaining high optical performance.

Further, in FIGS. 1, 5, 9, 13, 17, and 21, an asterisk “*” imparted to a particular surface indicates that the surface is aspheric. In each Fig., symbol (+) or (−) imparted to the symbol of each lens unit corresponds to the sign of the optical power of the lens unit. In each Fig., the straight line located on the most right-hand side indicates the position of the image surface S.

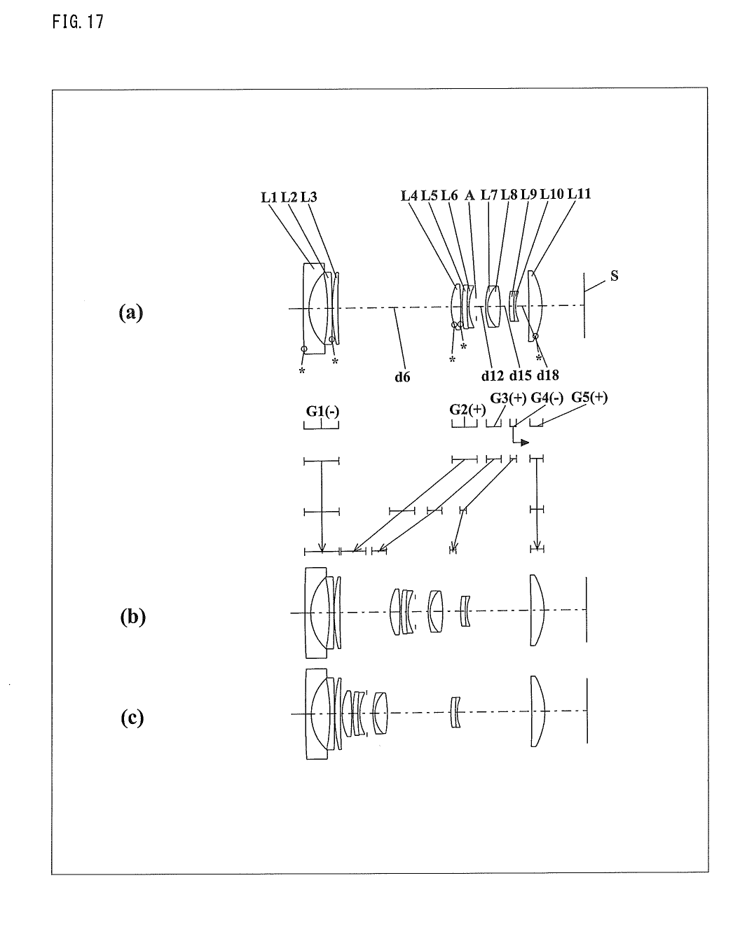

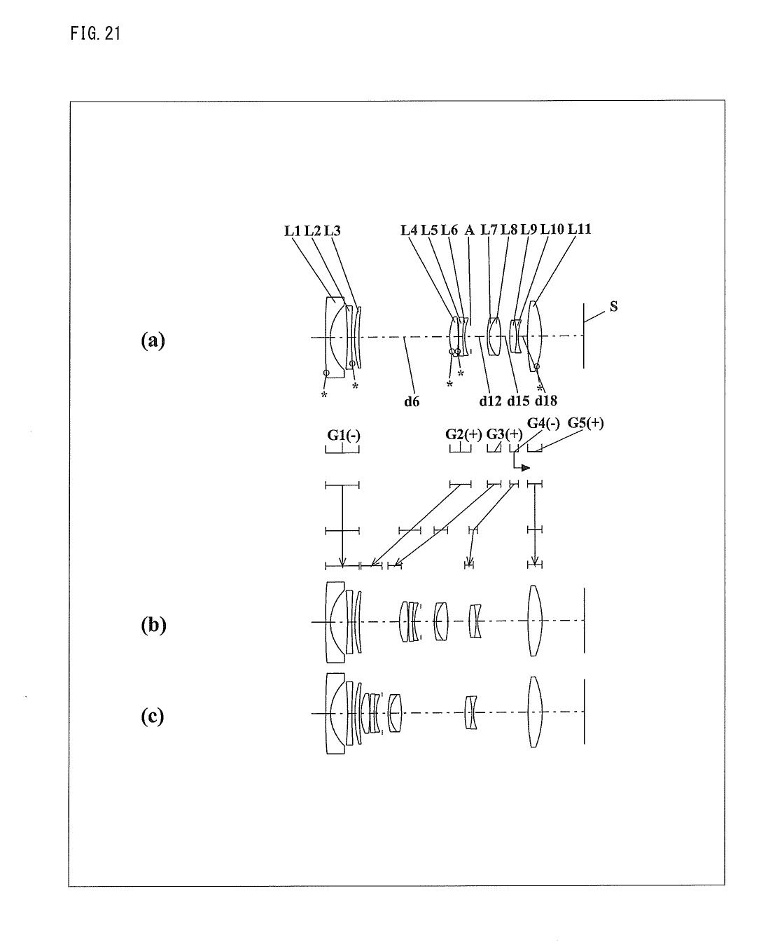

Further, as shown in FIGS. 1, 5, 9, and 13, an aperture diaphragm A is provided on the most image side in the second lens unit G2, i.e., on the image side relative to a fifth lens element L5. Further, as shown in FIGS. 17 and 21, an aperture diaphragm A is provided on the most image side in the second lens unit G2, i.e., on the image side relative to a sixth lens element L6.

As shown in FIG. 1, in the zoom lens system according to Embodiment 1, the first lens unit G1, in order from the object side to the image side, comprises: a bi-concave first lens element L1; and a positive meniscus second lens element L2 with the convex surface facing the object side. Among these, the first lens element L1 has an aspheric object side surface.

In the zoom lens system according to Embodiment 1, the second lens unit G2, in order from the object side to the image side, comprises: a bi-convex third lens element L3; a positive meniscus fourth lens element L4 with the convex surface facing the object side; and a negative meniscus fifth lens element L5 with the convex surface facing the object side. Among these, the fourth lens element L4 and the fifth lens element L5 are cemented with each other. The third lens element L3 has two aspheric surfaces.

In the zoom lens system according to Embodiment 1, the third lens unit G3, in order from the object side to the image side, comprises: a negative meniscus sixth lens element L6 with the convex surface facing the object side; and a bi-convex seventh lens element L7. The sixth lens element L6 and the seventh lens element L7 are cemented with each other.

In the zoom lens system according to Embodiment 1, the fourth lens unit G4, in order from the object side to the image side, comprises: a negative meniscus eighth lens element L8 with the convex surface facing the object side; and a negative meniscus ninth lens element L9 with the convex surface facing the object side. The eighth lens element L8 and the ninth lens element L9 are cemented with each other.

In the zoom lens system according to Embodiment 1, the fifth lens unit G5 comprises solely a positive meniscus tenth lens element L10 with the convex surface facing the image side. The tenth lens element L10 has an aspheric image side surface.

In the zoom lens system according to Embodiment 1, the sixth lens element L6 and the seventh lens element L7, which are components of the third lens unit G3, correspond to an image blur compensating lens unit described later, which moves in a direction perpendicular to the optical axis in order to optically compensate image blur.

In the zoom lens system according to Embodiment 1, in zooming from a wide-angle limit to a telephoto limit at the time of image taking, the second lens unit G2 and the third lens unit G3 monotonically move to the object side, the fourth lens unit G4 approximately monotonically moves to the object side, and the first lens unit G1 and the fifth lens unit G5 are fixed relative to the image surface S. That is, in zooming, the second lens unit G2, the third lens unit G3, and the fourth lens unit G4 individually move along the optical axis so that the interval between the first lens unit G1 and the second lens unit G2 decreases, the interval between the fourth lens unit G4 and the fifth lens unit G5 increases, and the interval between the second lens unit G2 and the third lens unit G3 and the interval between the third lens unit G3 and the fourth lens unit G4 vary.

Further, in the zoom lens system according to Embodiment 1, in focusing from an infinity in-focus condition to a close-object in-focus condition, the fourth lens unit G4 as a focusing lens unit moves to the image side along the optical axis in any zooming condition.

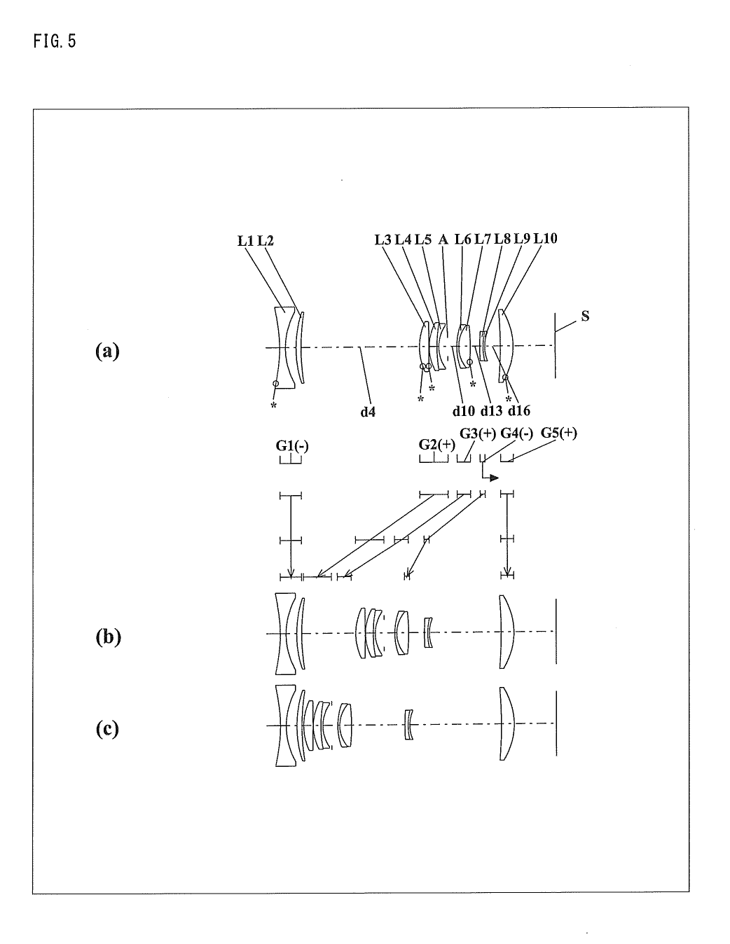

As shown in FIG. 5, in the zoom lens system according to Embodiment 2, the first lens unit G1, in order from the object side to the image side, comprises: a bi-concave first lens element L1; and a positive meniscus second lens element L2 with the convex surface facing the object side. Among these, the first lens element L1 has an aspheric object side surface.

In the zoom lens system according to Embodiment 2, the second lens unit G2, in order from the object side to the image side, comprises: a bi-convex third lens element L3; a positive meniscus fourth lens element L4 with the convex surface facing the object side; and a negative meniscus fifth lens element L5 with the convex surface facing the object side. Among these, the fourth lens element L4 and the fifth lens element L5 are cemented with each other. The third lens element L3 has two aspheric surfaces.

In the zoom lens system according to Embodiment 2, the third lens unit G3, in order from the object side to the image side, comprises: a negative meniscus sixth lens element L6 with the convex surface facing the object side; and a bi-convex seventh lens element L7. The sixth lens element L6 and the seventh lens element L7 are cemented with each other. The seventh lens element L7 has an aspheric image side surface.

In the zoom lens system according to Embodiment 2, the fourth lens unit G4, in order from the object side to the image side, comprises: a negative meniscus eighth lens element L8 with the convex surface facing the object side; and a negative meniscus ninth lens element L9 with the convex surface facing the object side. The eighth lens element L8 and the ninth lens element L9 are cemented with each other.

In the zoom lens system according to Embodiment 2, the fifth lens unit G5 comprises solely a positive meniscus tenth lens element L10 with the convex surface facing the image side. The tenth lens element L10 has an aspheric image side surface.

In the zoom lens system according to Embodiment 2, the sixth lens element L6 and the seventh lens element L7, which are components of the third lens unit G3, correspond to an image blur compensating lens unit described later, which moves in a direction perpendicular to the optical axis in order to optically compensate image blur.

In the zoom lens system according to Embodiment 2, in zooming from a wide-angle limit to a telephoto limit at the time of image taking, the second lens unit G2 and the third lens unit G3 monotonically move to the object side, the fourth lens unit G4 approximately monotonically moves to the object side, and the first lens unit G1 and the fifth lens unit G5 are fixed relative to the image surface S. That is, in zooming, the second lens unit G2, the third lens unit G3, and the fourth lens unit G4 individually move along the optical axis so that the interval between the first lens unit G1 and the second lens unit G2 decreases, the interval between the fourth lens unit G4 and the fifth lens unit G5 increases, and the interval between the second lens unit G2 and the third lens unit G3 and the interval between the third lens unit G3 and the fourth lens unit G4 vary.

Further, in the zoom lens system according to Embodiment 2, in focusing from an infinity in-focus condition to a close-object in-focus condition, the fourth lens unit G4 as a focusing lens unit moves to the image side along the optical axis in any zooming condition.

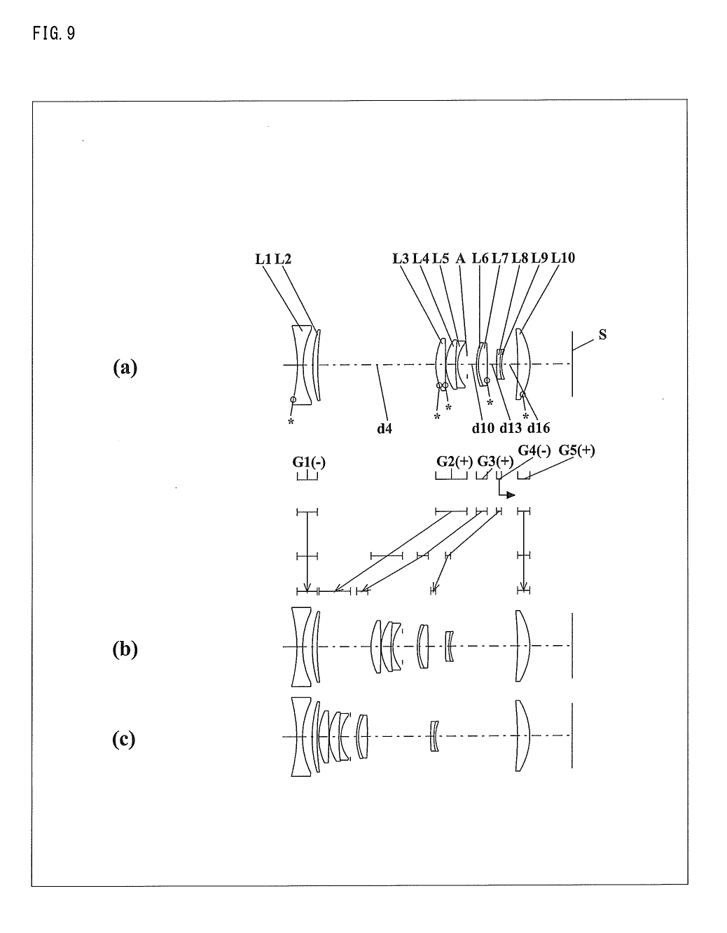

As shown in FIG. 9, in the zoom lens system according to Embodiment 3, the first lens unit G1, in order from the object side to the image side, comprises: a bi-concave first lens element L1; and a positive meniscus second lens element L2 with the convex surface facing the object side. Among these, the first lens element L1 has an aspheric object side surface.

In the zoom lens system according to Embodiment 3, the second lens unit G2, in order from the object side to the image side, comprises: a bi-convex third lens element L3; a positive meniscus fourth lens element L4 with the convex surface facing the object side; and a negative meniscus fifth lens element L5 with the convex surface facing the object side. Among these, the fourth lens element L4 and the fifth lens element L5 are cemented with each other. The third lens element L3 has two aspheric surfaces.

In the zoom lens system according to Embodiment 3, the third lens unit G3, in order from the object side to the image side, comprises: a negative meniscus sixth lens element L6 with the convex surface facing the object side; and a bi-convex seventh lens element L7. The sixth lens element L6 and the seventh lens element L7 are cemented with each other. The seventh lens element L7 has an aspheric image side surface.

In the zoom lens system according to Embodiment 3, the fourth lens unit G4, in order from the object side to the image side, comprises: a negative meniscus eighth lens element L8 with the convex surface facing the object side; and a negative meniscus ninth lens element L9 with the convex surface facing the object side. The eighth lens element L8 and the ninth lens element L9 are cemented with each other.

In the zoom lens system according to Embodiment 3, the fifth lens unit G5 comprises solely a positive meniscus tenth lens element L10 with the convex surface facing the image side. The tenth lens element L10 has an aspheric image side surface.

In the zoom lens system according to Embodiment 3, the sixth lens element L6 and the seventh lens element L7, which are components of the third lens unit G3, correspond to an image blur compensating lens unit described later, which moves in a direction perpendicular to the optical axis in order to optically compensate image blur.

In the zoom lens system according to Embodiment 3, in zooming from a wide-angle limit to a telephoto limit at the time of image taking, the second lens unit G2 and the third lens unit G3 monotonically move to the object side, the fourth lens unit G4 approximately monotonically moves to the object side, and the first lens unit G1 and the fifth lens unit G5 are fixed relative to the image surface S. That is, in zooming, the second lens unit G2, the third lens unit G3, and the fourth lens unit G4 individually move along the optical axis so that the interval between the first lens unit G1 and the second lens unit G2 decreases, the interval between the fourth lens unit G4 and the fifth lens unit G5 increases, and the interval between the second lens unit G2 and the third lens unit G3 and the interval between the third lens unit G3 and the fourth lens unit G4 vary.

Further, in the zoom lens system according to Embodiment 3, in focusing from an infinity in-focus condition to a close-object in-focus condition, the fourth lens unit G4 as a focusing lens unit moves to the image side along the optical axis in any zooming condition.

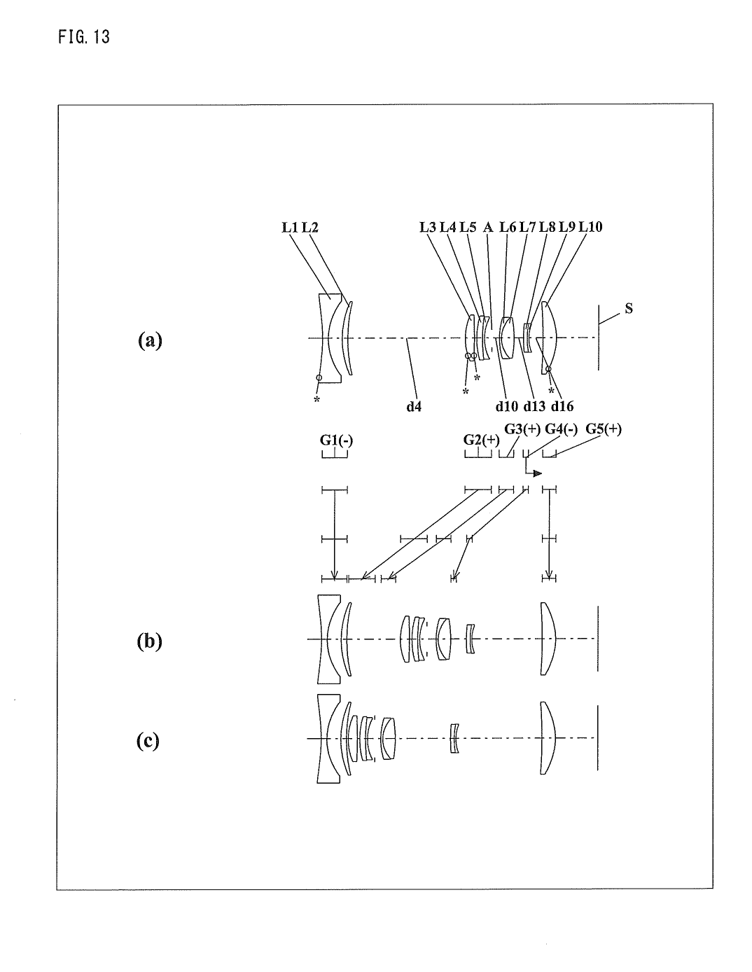

As shown in FIG. 13, in the zoom lens system according to Embodiment 4, the first lens unit G1, in order from the object side to the image side, comprises: a bi-concave first lens element L1; and a positive meniscus second lens element L2 with the convex surface facing the object side. Among these, the first lens element L1 has an aspheric object side surface.

In the zoom lens system according to Embodiment 4, the second lens unit G2, in order from the object side to the image side, comprises: a bi-convex third lens element L3; a positive meniscus fourth lens element L4 with the convex surface facing the object side; and a negative meniscus fifth lens element L5 with the convex surface facing the object side. Among these, the fourth lens element L4 and the fifth lens element L5 are cemented with each other. The third lens element L3 has two aspheric surfaces.

In the zoom lens system according to Embodiment 4, the third lens unit G3, in order from the object side to the image side, comprises: a negative meniscus sixth lens element L6 with the convex surface facing the object side; and a bi-convex seventh lens element L7. The sixth lens element L6 and the seventh lens element L7 are cemented with each other.

In the zoom lens system according to Embodiment 4, the fourth lens unit G4, in order from the object side to the image side, comprises: a negative meniscus eighth lens element L8 with the convex surface facing the object side; and a negative meniscus ninth lens element L9 with the convex surface facing the object side. The eighth lens element L8 and the ninth lens element L9 are cemented with each other.

In the zoom lens system according to Embodiment 4, the fifth lens unit G5 comprises solely a positive meniscus tenth lens element L10 with the convex surface facing the image side. The tenth lens element L10 has an aspheric image side surface.

In the zoom lens system according to Embodiment 4, the sixth lens element L6 and the seventh lens element L7, which are components of the third lens unit G3, correspond to an image blur compensating lens unit described later, which moves in a direction perpendicular to the optical axis in order to optically compensate image blur.

In the zoom lens system according to Embodiment 4, in zooming from a wide-angle limit to a telephoto limit at the time of image taking, the second lens unit G2 and the third lens unit G3 monotonically move to the object side, the fourth lens unit G4 approximately monotonically moves to the object side, and the first lens unit G1 and the fifth lens unit G5 are fixed relative to the image surface S. That is, in zooming, the second lens unit G2, the third lens unit G3, and the fourth lens unit G4 individually move along the optical axis so that the interval between the first lens unit G1 and the second lens unit G2 decreases, the interval between the fourth lens unit G4 and the fifth lens unit G5 increases, and the interval between the second lens unit G2 and the third lens unit G3 and the interval between the third lens unit G3 and the fourth lens unit G4 vary.

Further, in the zoom lens system according to Embodiment 4, in focusing from an infinity in-focus condition to a close-object in-focus condition, the fourth lens unit G4 as a focusing lens unit moves to the image side along the optical axis in any zooming condition.

As shown in FIG. 17, in the zoom lens system according to Embodiment 5, the first lens unit G1, in order from the object side to the image side, comprises: a negative meniscus first lens element L1 with the convex surface facing the object side; a bi-concave second lens element L2; and a positive meniscus third lens element L3 with the convex surface facing the object side. Among these, the first lens element L1 has an aspheric object side surface, and the second lens element L2 has an aspheric image side surface.

In the zoom lens system according to Embodiment 5, the second lens unit G2, in order from the object side to the image side, comprises: a bi-convex fourth lens element L4; a positive meniscus fifth lens element L5 with the convex surface facing the object side; and a negative meniscus sixth lens element L6 with the convex surface facing the object side. Among these, the fifth lens element L5 and the sixth lens element L6 are cemented with each other. The fourth lens element L4 has two aspheric surfaces.

In the zoom lens system according to Embodiment 5, the third lens unit G3, in order from the object side to the image side, comprises: a negative meniscus seventh lens element L7 with the convex surface facing the object side; and a bi-convex eighth lens element L8. The seventh lens element L7 and the eighth lens element L8 are cemented with each other.

In the zoom lens system according to Embodiment 5, the fourth lens unit G4, in order from the object side to the image side, comprises: a positive meniscus ninth lens element L9 with the convex surface facing the object side; and a negative meniscus tenth lens element L10 with the convex surface facing the object side. The ninth lens element L9 and the tenth lens element L10 are cemented with each other.

In the zoom lens system according to Embodiment 5, the fifth lens unit G5 comprises solely a positive meniscus eleventh lens element L11 with the convex surface facing the image side. The eleventh lens element L11 has an aspheric image side surface.

In the zoom lens system according to Embodiment 5, the seventh lens element L7 and the eighth lens element L8, which are components of the third lens unit G3, correspond to an image blur compensating lens unit described later, which moves in a direction perpendicular to the optical axis in order to optically compensate image blur.

In the zoom lens system according to Embodiment 5, in zooming from a wide-angle limit to a telephoto limit at the time of image taking, the second lens unit G2 and the third lens unit G3 monotonically move to the object side, the fourth lens unit G4 approximately monotonically moves to the object side, and the first lens unit G1 and the fifth lens unit G5 are fixed relative to the image surface S. That is, in zooming, the second lens unit G2, the third lens unit G3, and the fourth lens unit G4 individually move along the optical axis so that the interval between the first lens unit G1 and the second lens unit G2 decreases, the interval between the fourth lens unit G4 and the fifth lens unit G5 increases, and the interval between the second lens unit G2 and the third lens unit G3 and the interval between the third lens unit G3 and the fourth lens unit G4 vary.

Further, in the zoom lens system according to Embodiment 5, in focusing from an infinity in-focus condition to a close-object in-focus condition, the fourth lens unit G4 as a focusing lens unit moves to the image side along the optical axis in any zooming condition.

As shown in FIG. 21, in the zoom lens system according to Embodiment 6, the first lens unit G1, in order from the object side to the image side, comprises: a negative meniscus first lens element L1 with the convex surface facing the object side; a bi-concave second lens element L2; and a positive meniscus third lens element L3 with the convex surface facing the object side. Among these, the first lens element L1 has an aspheric object side surface, and the second lens element L2 has an aspheric image side surface.

In the zoom lens system according to Embodiment 6, the second lens unit G2, in order from the object side to the image side, comprises: a bi-convex fourth lens element L4; a negative meniscus fifth lens element L5 with the convex surface facing the object side; and a negative meniscus sixth lens element L6 with the convex surface facing the object side. Among these, the fifth lens element L5 and the sixth lens element L6 are cemented with each other. The fourth lens element L4 has two aspheric surfaces.

In the zoom lens system according to Embodiment 6, the third lens unit G3, in order from the object side to the image side, comprises: a negative meniscus seventh lens element L7 with the convex surface facing the object side; and a bi-convex eighth lens element L8. The seventh lens element L7 and the eighth lens element L8 are cemented with each other.

In the zoom lens system according to Embodiment 6, the fourth lens unit G4, in order from the object side to the image side, comprises: a bi-convex ninth lens element L9; and a bi-concave tenth lens element L10. The ninth lens element L9 and the tenth lens element L10 are cemented with each other.

In the zoom lens system according to Embodiment 6, the fifth lens unit G5 comprises solely a bi-convex eleventh lens element L11. The eleventh lens element L11 has an aspheric image side surface.

In the zoom lens system according to Embodiment 6, the seventh lens element L7 and the eighth lens element L8, which are components of the third lens unit G3, correspond to an image blur compensating lens unit described later, which moves in a direction perpendicular to the optical axis in order to optically compensate image blur.

In the zoom lens system according to Embodiment 6, in zooming from a wide-angle limit to a telephoto limit at the time of image taking, the second lens unit G2 and the third lens unit G3 monotonically move to the object side, the fourth lens unit G4 moves with locus of a convex to the object side, and the first lens unit G1 and the fifth lens unit G5 are fixed relative to the image surface S. That is, in zooming, the second lens unit G2, the third lens unit G3, and the fourth lens unit G4 individually move along the optical axis so that the interval between the first lens unit G1 and the second lens unit G2 decreases, the interval between the third lens unit G3 and the fourth lens unit G4 increases, and the interval between the second lens unit G2 and the third lens unit G3 and the interval between the fourth lens unit G4 and the fifth lens unit G5 vary.

Further, in the zoom lens system according to Embodiment 6, in focusing from an infinity in-focus condition to a close-object in-focus condition, the fourth lens unit G4 as a focusing lens unit moves to the image side along the optical axis in any zooming condition.

In the zoom lens systems according to Embodiments 1 to 6, since the lens unit located closest to the object side, i.e., the first lens unit G1, has negative optical power, the front lens diameter is reduced, and thus weight reduction of the zoom lens system is realized.

In the zoom lens systems according to Embodiments 1 to 6, in zooming from a wide-angle limit to a telephoto limit at the time of image taking, the first lens unit G1 is fixed relative to the image surface. Therefore, weight reduction of the movable lens units is achieved, and thereby actuators can be arranged inexpensively. In addition, generation of noise during zooming is suppressed. Moreover, since the overall length of lens system is not varied, a user can easily operate the lens system, and entry of dust or the like into the lens system is sufficiently prevented.

Further, in the zoom lens systems according to Embodiments 1 to 6, in zooming from a wide-angle limit to a telephoto limit at the time of image taking, the lens unit located closest to the image side, i.e., the fifth lens unit G5, is fixed relative to the image surface. Therefore, entry of dust or the like into the lens system is sufficiently prevented.

In the zoom lens systems according to Embodiments 1 to 6, the first lens unit G1 includes at least one lens element having positive optical power, and at least one lens element having negative optical power. Therefore, generation of aberrations due to decentering of the first lens unit G1 is sufficiently suppressed.

The zoom lens systems according to Embodiments 1 to 6 are each provided with an image blur compensating lens unit which moves in a direction perpendicular to the optical axis. The image blur compensating lens unit compensates image point movement caused by vibration of the entire system, that is, optically compensates image blur caused by hand blurring, vibration and the like.

When image point movement caused by vibration of the entire system is to be compensated, the image blur compensating lens unit moves in the direction perpendicular to the optical axis, so that image blur is compensated in a state that size increase in the entire zoom lens system is suppressed to realize a compact construction and that excellent imaging characteristics such as small decentering coma aberration and small decentering astigmatism are satisfied.

The image blur compensating lens unit according to the present invention may be a single lens unit. If a single lens unit is composed of a plurality of lens elements, the image blur compensating lens unit may be any one lens element or a plurality of adjacent lens elements among the plurality of lens elements.

In the zoom lens systems according to Embodiments 1 to 6, the image blur compensating lens unit has positive optical power while a focusing lens unit described later has negative optical power. Therefore, the optical powers thereof are enhanced with each other, and thereby the amount of lens movement in focusing is reduced. Moreover, the amount of movement of the image blur compensating lens unit in the direction perpendicular to the optical axis is also reduced.

Further, when the image blur compensating lens unit and the focusing lens unit described later are arranged adjacent to each other as in the zoom lens systems according to Embodiments 1 to 6, the optical powers thereof are further enhanced with each other.

In the zoom lens systems according to Embodiments 1 to 6, among the lens units located on the image side relative to the aperture diaphragm, the lens unit having negative optical power, i.e., the fourth lens unit G4, is a focusing lens unit which moves along the optical axis in focusing from an infinity in-focus condition to a close-object in-focus condition on at least one zooming position from a wide-angle limit to a telephoto limit. Therefore, the overall length of lens system is shortened. For example, by increasing the negative optical power, the overall length of lens system is further shortened, and thereby the amount of lens movement in focusing is further reduced, resulting in an advantage to size reduction of the lens system.

In the zoom lens systems according to Embodiments 1 to 6, a lens unit having positive optical power is provided on each of the object side and the image side of the focusing lens unit. Therefore, the optical power of the focusing lens unit is increased, and thereby the amount of lens movement in focusing is reduced, resulting in a further advantage to size reduction of the lens system.

The zoom lens systems according to Embodiments 1 to 6 each have a five-unit construction including first to fifth lens units G1 to G5. In the present invention, however, the number of lens units constituting the zoom lens system is not particularly limited so long as the lens unit located closest to the object side has negative optical power, the lens unit located closest to the object side and the lens unit located closest to the image side are fixed relative to the image surface in zooming, the lens unit located closest to the object side includes at least one lens element having positive optical power and at least one lens element having negative optical power, and the image blur compensating lens unit is provided. Further, the optical powers of the respective lens units constituting the zoom lens system are not particularly limited.

The following description is given for conditions preferred to be satisfied by a zoom lens system like the zoom lens systems according to Embodiments 1 to 6. Here, a plurality of preferable conditions are set forth for the zoom lens system according to each embodiment. A construction that satisfies all the plurality of conditions is most desirable for the zoom lens system. However, when an individual condition is satisfied, a zoom lens system having the corresponding effect is obtained.

For example, a zoom lens system like the zoom lens systems according to Embodiments 1 to 6, which includes a plurality of lens units each comprising at least one lens element, in which a lens unit located closest to the object side has negative optical power, the lens unit located closest to the object side and a lens unit located closest to the image side are fixed relative to the image surface in zooming from a wide-angle limit to a telephoto limit at the time of image taking, the lens unit located closest to the object side includes at least one lens element having positive optical power and at least one lens element having negative optical power, and an image blur compensating lens unit is provided, which moves in a direction perpendicular to the optical axis in order to optically compensate image blur (this lens configuration is referred to as a basic configuration of the embodiments, hereinafter), preferably satisfies the following condition (1).

−3.0<fₙ/f_{W}<−0.3 (1)

where

fₙ is a composite focal length of the lens unit having negative optical power, which is a focusing lens unit, and

f_{W} is a focal length of the entire system at a wide-angle limit.

The condition (1) sets forth the relationship between the focal length of the lens unit having negative optical power, which is a focusing lens unit, and the focal length of the entire system at a wide-angle limit. When the value goes below the lower limit of the condition (1), the amount of lens movement in focusing increases, which might cause an increase in the overall length of lens system. On the other hand, when the value exceeds the upper limit of the condition (1), the optical power of the focusing lens unit excessively increases, and spherical aberration and curvature of field occur in focusing. Thus, the performance in a close-object in-focus condition is deteriorated. In addition, generation of aberration due to decentering of the focusing lens unit might be increased.

When at least one of the following conditions (1)′ and (1)″ is satisfied, the above-mentioned effect is achieved more successfully.

−2.5<fₙ/f_{W} (1)′

fₙ/f_{W}<−0.4 (1)″

For example, a zoom lens system having the basic configuration like the zoom lens systems according to Embodiments 1 to 6 preferably satisfies the following condition (2).

0.1<T₁/f_{W}<1.5 (2)

where

T₁ is an axial thickness of the lens unit located closest to the object side, and

f_{W} is a focal length of the entire system at a wide-angle limit.

The condition (2) sets forth the relationship between the axial thickness of the lens unit located closest to the object side, i.e., the first lens unit, and the focal length of the entire system at a wide-angle limit. When the value goes below the lower limit of the condition (2), the optical power of the first lens unit cannot be increased, which might cause an increase in the size of the zoom lens system. On the other hand, when the value exceeds the upper limit of the condition (2), the thickness of the first lens unit is increased. Also in this case, the size of the zoom lens system might be increased.

When at least one of the following conditions (2)′ and (2)″ is satisfied, the above-mentioned effect is achieved more successfully.

0.17<T₁/f_{W} (2)′

T₁/f_{W}<1.20 (2)″

For example, a zoom lens system having the basic configuration like the zoom lens systems according to Embodiments 1 to 6 preferably satisfies the following condition (3).

1.0<|f₁/f_{W}|<4.5 (3)

where

f₁ is a composite focal length of the lens unit located closest to the object side, and

f_{W} is a focal length of the entire system at a wide-angle limit.

The condition (3) sets forth the relationship between the focal length of the first lens unit and the focal length of the entire system at a wide-angle limit. When the value goes below the lower limit of the condition (3), the optical power of the first lens unit increases, which might cause an increase in generation of aberration due to decentering of the first lens unit. On the other hand, when the value exceeds the upper limit of the condition (3), the thickness of the first lens unit is increased, which might cause an increase in the size of the zoom lens system.

When at least one of the following conditions (3)′ and (3)″ is satisfied, the above-mentioned effect is achieved more successfully.

1.2<|f₁/f_{W}| (3)′

|f₁/f_{W}|<4.0 (3)″

For example, a zoom lens system having the basic configuration like the zoom lens systems according to Embodiments 1 to 6 preferably satisfies the following condition (4).

1.0<|f₂/f_{W}|<4.0 (4)

where

f₂ is a composite focal length of a lens unit located having one air space toward the image side from the lens unit located closest to the object side, and

f_{W} is a focal length of the entire system at a wide-angle limit.

The condition (4) sets forth the relationship between the focal length of the lens unit located just on the image side of the first lens unit, i.e., the second lens unit, and the focal length of the entire system at a wide-angle limit. When the value goes below the lower limit of the condition (4), the optical power of the second lens unit increases, which might cause an increase in generation of aberration due to decentering of the second lens unit. On the other hand, when the value exceeds the upper limit of the condition (4), the amount of movement of the second lens unit increases in zooming, which might cause an increase in the overall length of lens system.

When at least one of the following conditions (4)′ and (4)″ is satisfied, the above-mentioned effect is achieved more successfully.

1.5<|f₂/f_{W}| (4)′

|f₂/f_{W}|<3.0 (4)″

For example, a zoom lens system having the basic configuration like the zoom lens systems according to Embodiments 1 to 6 preferably satisfies the following condition (5).

0.1<(T₁+T₂)/f_{W}<2.5 (5)

where

T₁ is an axial thickness of the lens unit located closest to the object side,

T₂ is an axial thickness of the lens unit located having one air space toward the image side from the lens unit located closest to the object side, and

f_{W} is a focal length of the entire system at a wide-angle limit.

The condition (5) sets forth the relationship between the sum of the axial thickness of the first lens unit and the axial thickness of the second lens unit, and the focal length of the entire system at a wide-angle limit. When the value goes below the lower limit of the condition (5), the optical powers of the lens units cannot be increased, which might cause an increase in the size of the zoom lens system. On the other hand, when the value exceeds the upper limit of the condition (5), the thicknesses of the lens units are increased. Also in this case, the size of the zoom lens system might be increased.

When at least one of the following conditions (5)′ and (5)″ is satisfied, the above-mentioned effect is achieved more successfully.

0.2<(T₁+T₂)/f_{W} (5)′

(T₁+T₂)/f_{W}<2.0 (5)″

For example, a zoom lens system having the basic configuration like the zoom lens systems according to Embodiments 1 to 6 preferably satisfies the following condition (6).

0.1<(T₁+T₂)/H<2.0 (6)

where

T₁ is an axial thickness of the lens unit located closest to the object side,

T₂ is an axial thickness of the lens unit located having one air space toward the image side from the lens unit located closest to the object side, and

H is an image height.

The condition (6) sets forth the relationship between the sum of the axial thickness of the first lens unit and the axial thickness of the second lens unit, and the image height. When the value goes below the lower limit of the condition (6), the optical powers of the lens units cannot be increased, which might cause an increase in the size of the zoom lens system. On the other hand, when the value exceeds the upper limit of the condition (6), the thicknesses of the lens units are increased. Also in this case, the size of the zoom lens system might be increased.

When at least one of the following conditions (6)′ and (6)″ is satisfied, the above-mentioned effect is achieved more successfully.

1.0<(T₁+T₂)/H (6)′

(T₁+T₂)/H<1.9 (6)″

The individual lens units constituting the zoom lens systems according to Embodiments 1 to 6 are each composed exclusively of refractive type lens elements that deflect incident light by refraction (that is, lens elements of a type in which deflection is achieved at the interface between media having different refractive indices). However, the present invention is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved. Thus, such a configuration is preferable.

### Embodiment 7

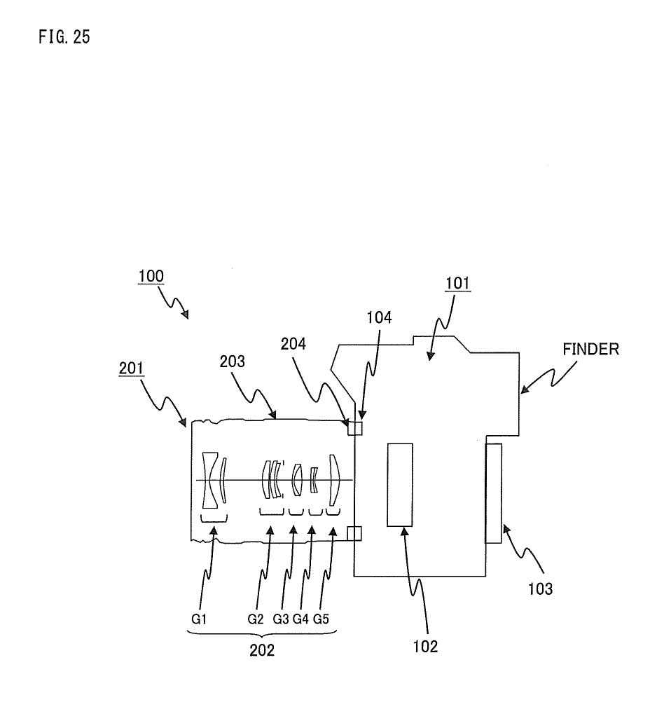

FIG. 25 is a schematic construction diagram of an interchangeable-lens type digital camera system according to Embodiment 7.

The interchangeable-lens type digital camera system 100 according to Embodiment 7 includes a camera body 101, and an interchangeable lens apparatus 201 which is detachably connected to the camera body 101.

The camera body 101 includes: an image sensor 102 which receives an optical image formed by a zoom lens system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a zoom lens system 202 according to any of Embodiments 1 to 6; a lens barrel 203 which holds the zoom lens system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201. In FIG. 25, the zoom lens system according to Embodiment 1 is employed as the zoom lens system 202.

In Embodiment 7, since the zoom lens system 202 according to any of Embodiments 1 to 6 is employed, a compact interchangeable lens apparatus having excellent imaging performance can be realized at low cost. Moreover, size reduction and cost reduction of the entire camera system 100 according to Embodiment 7 can be achieved. In the zoom lens systems according to Embodiments 1 to 6, the entire zooming range need not be used. That is, in accordance with a desired zooming range, a range where satisfactory optical performance is obtained may exclusively be used. Then, the zoom lens system may be used as one having a lower magnification than the zoom lens systems described in Embodiments 1 to 6.

Numerical examples are described below in which the zoom lens systems according to Embodiments 1 to 6 are implemented. Here, in the numerical examples, the units of length are all “mm”, while the units of view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspherical surfaces, and the aspherical surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

An is a n-th order aspherical coefficient.

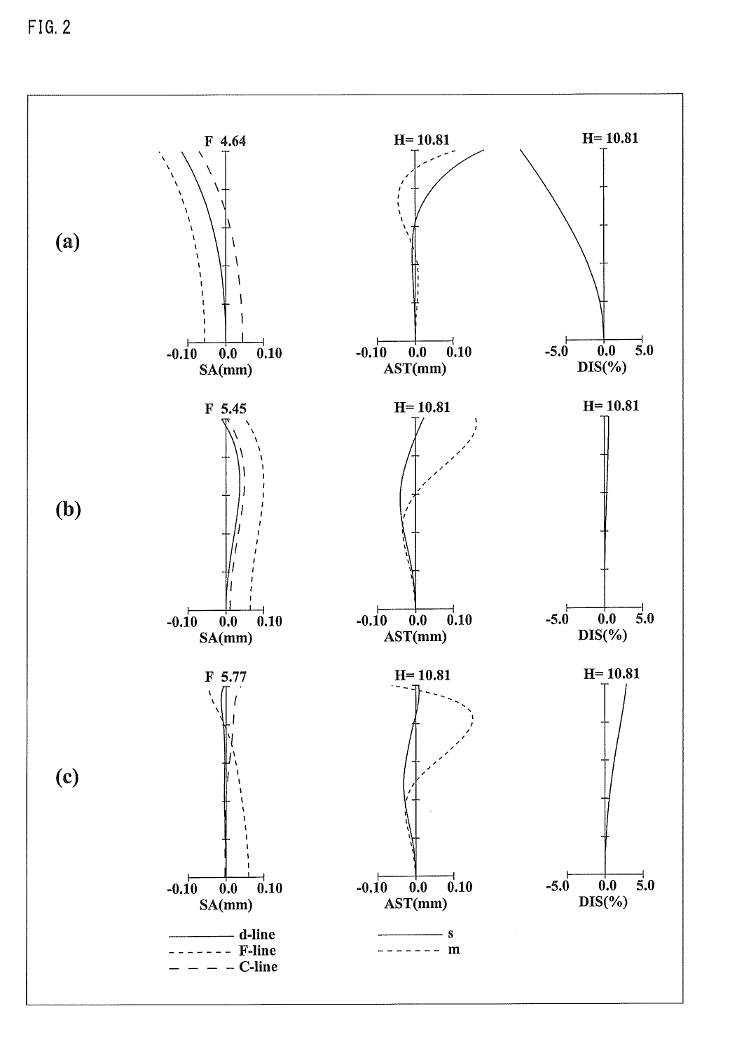

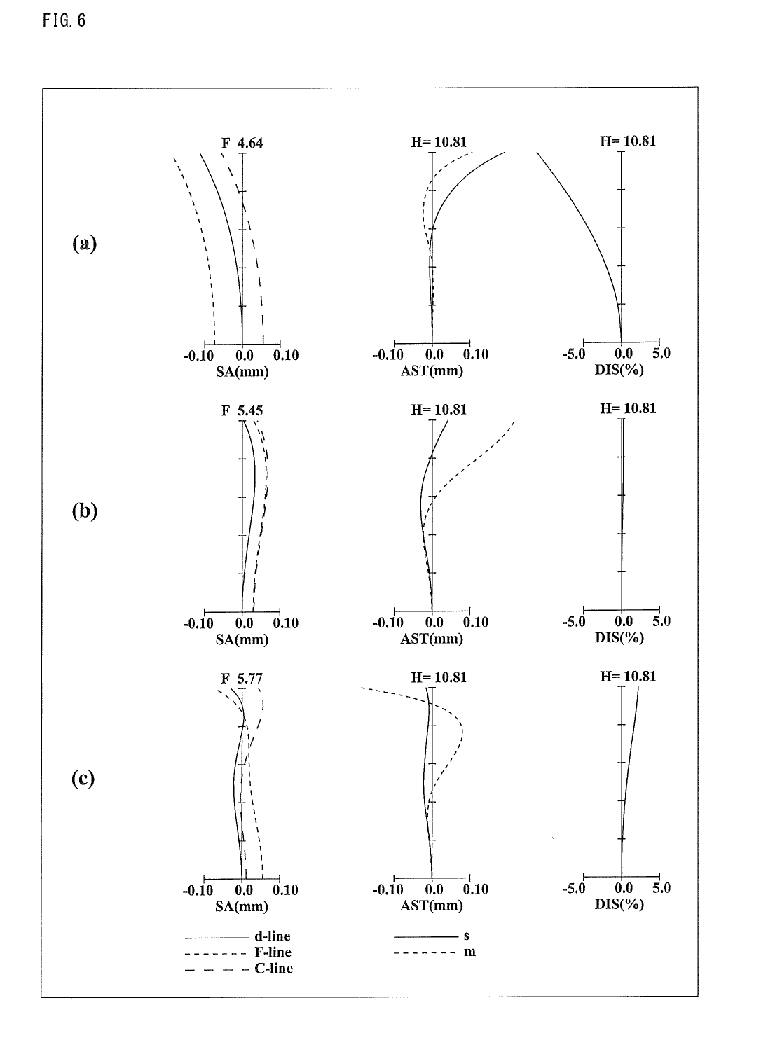

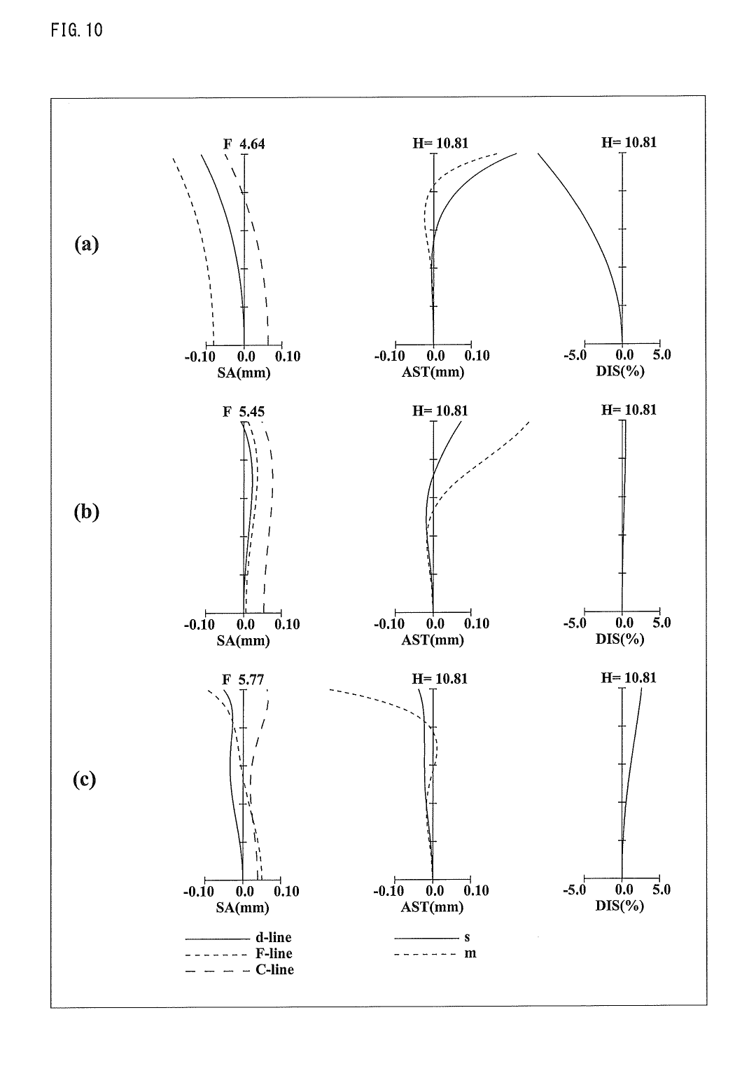

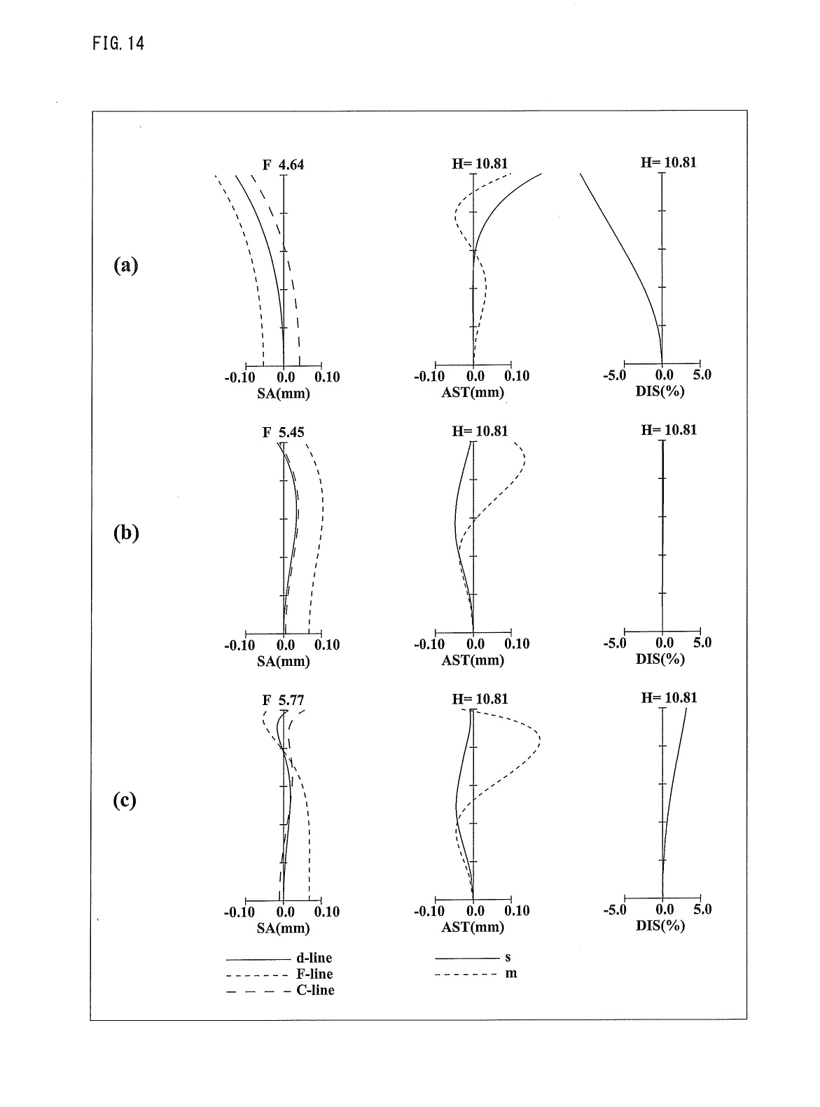

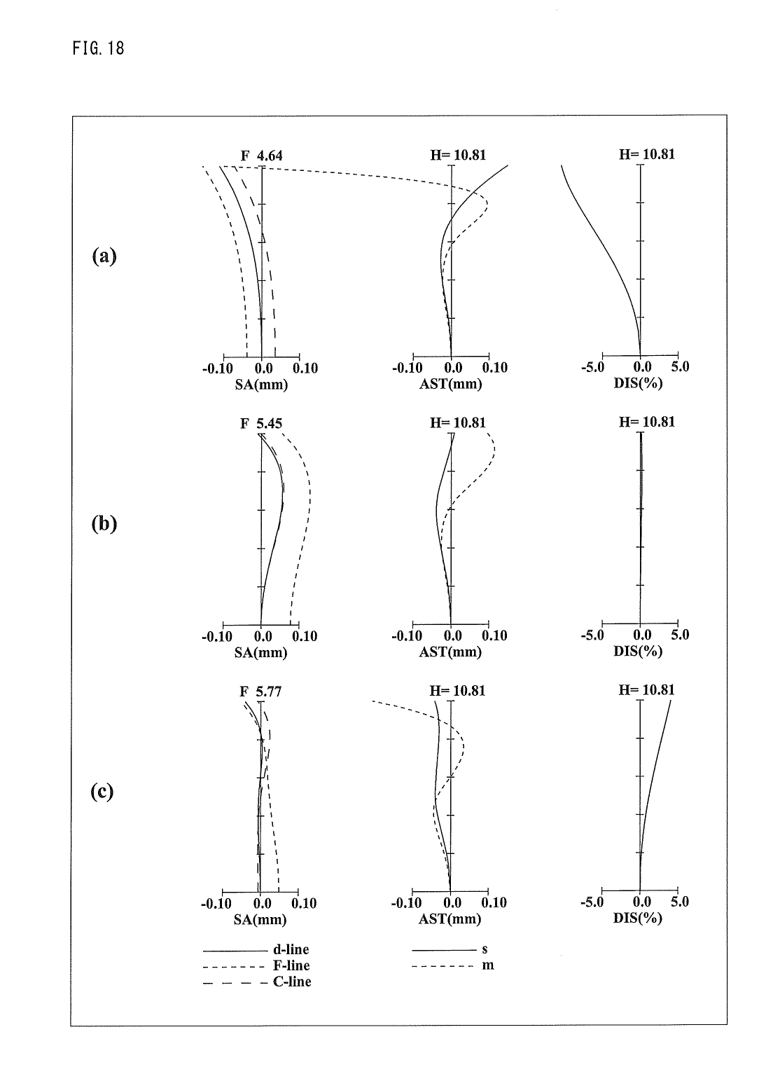

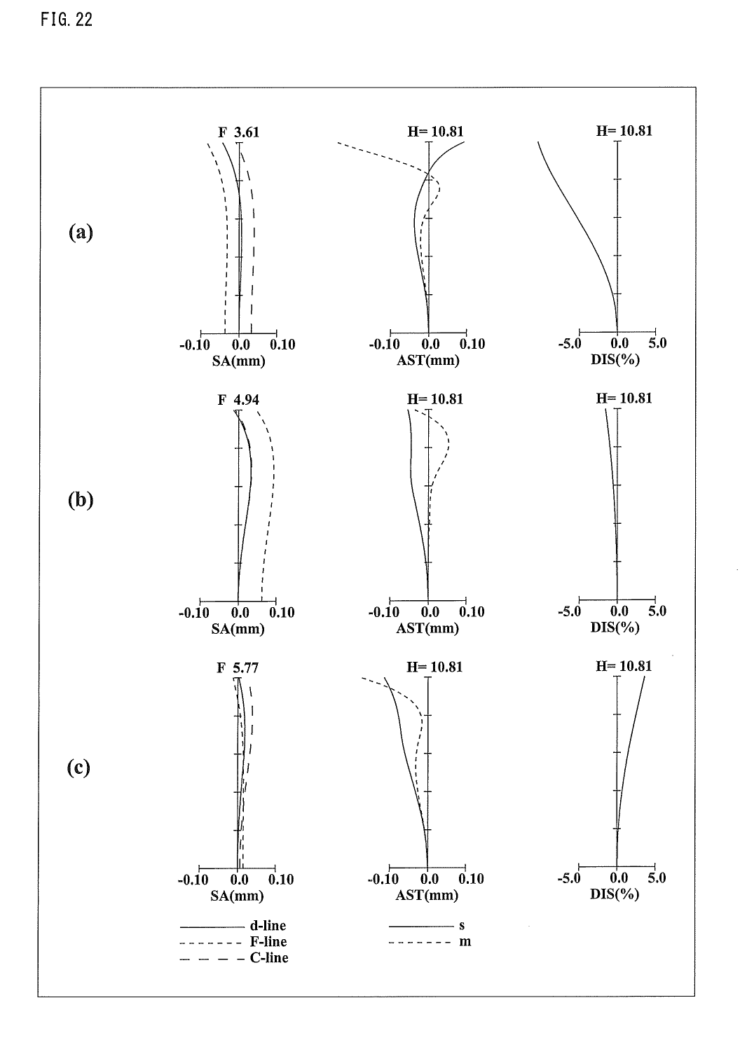

FIGS. 2, 6, 10, 14, 18, and 22 are longitudinal aberration diagrams of an infinity in-focus condition of the zoom lens systems according to Examples 1 to 6, respectively.

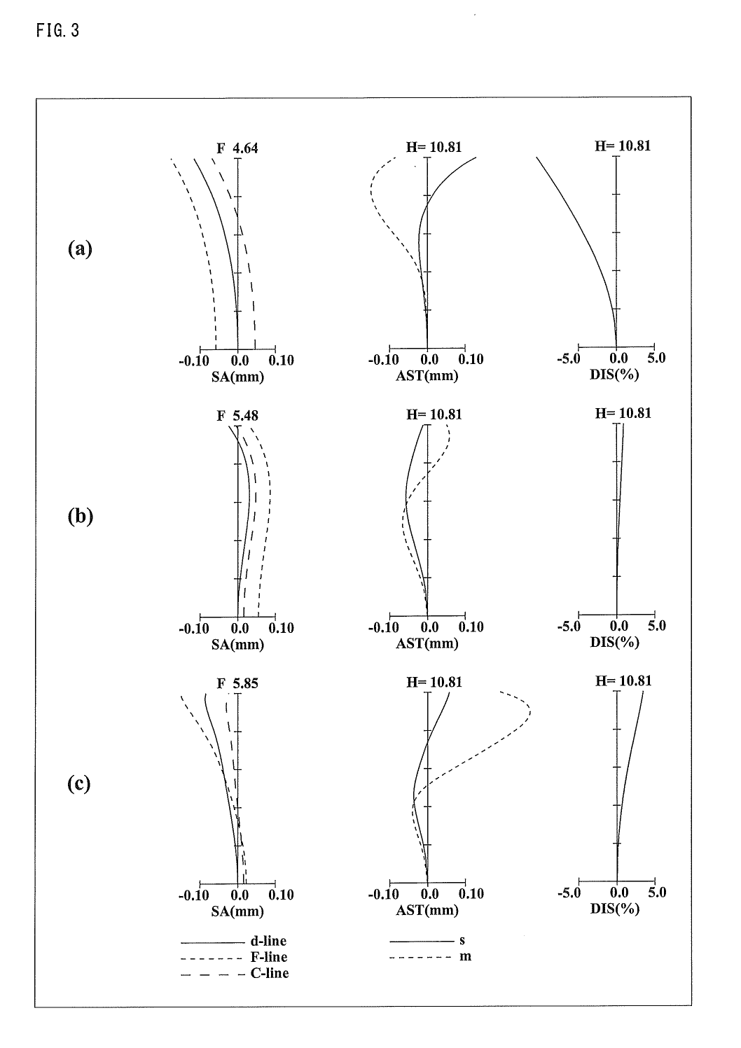

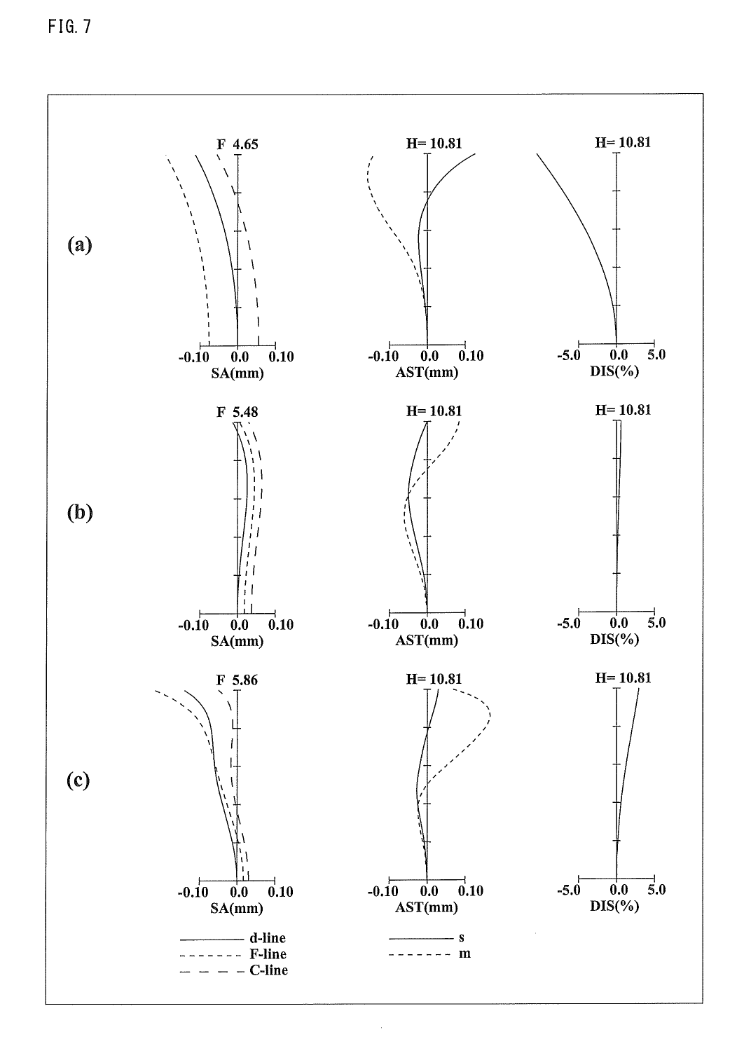

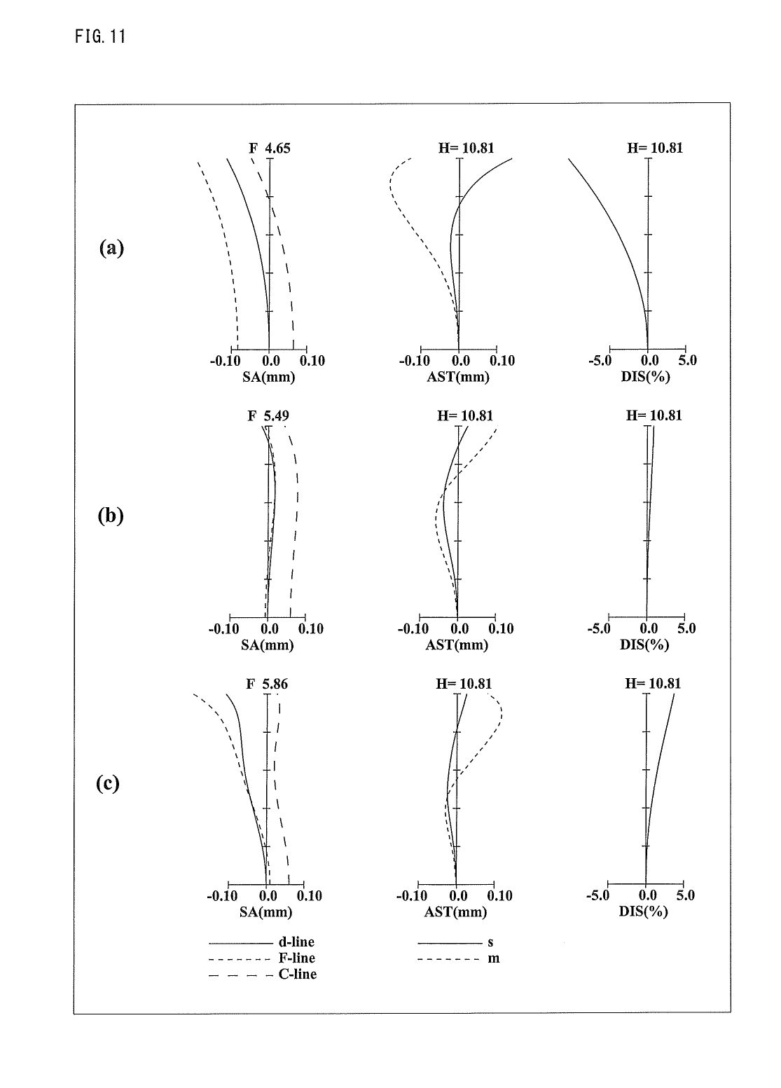

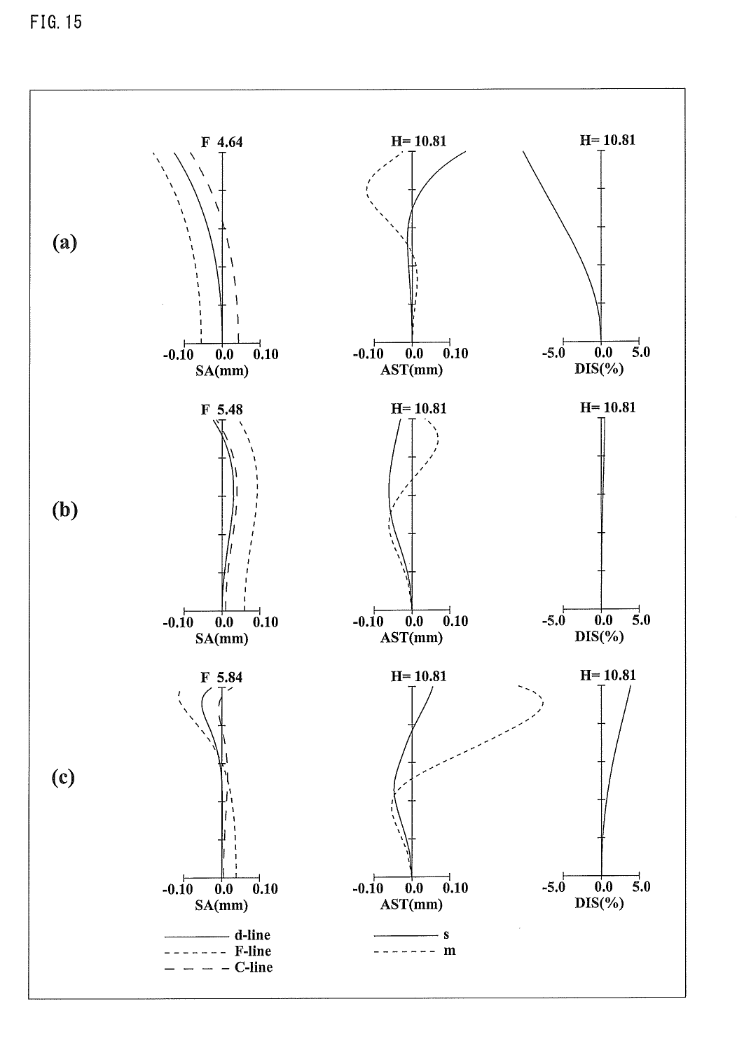

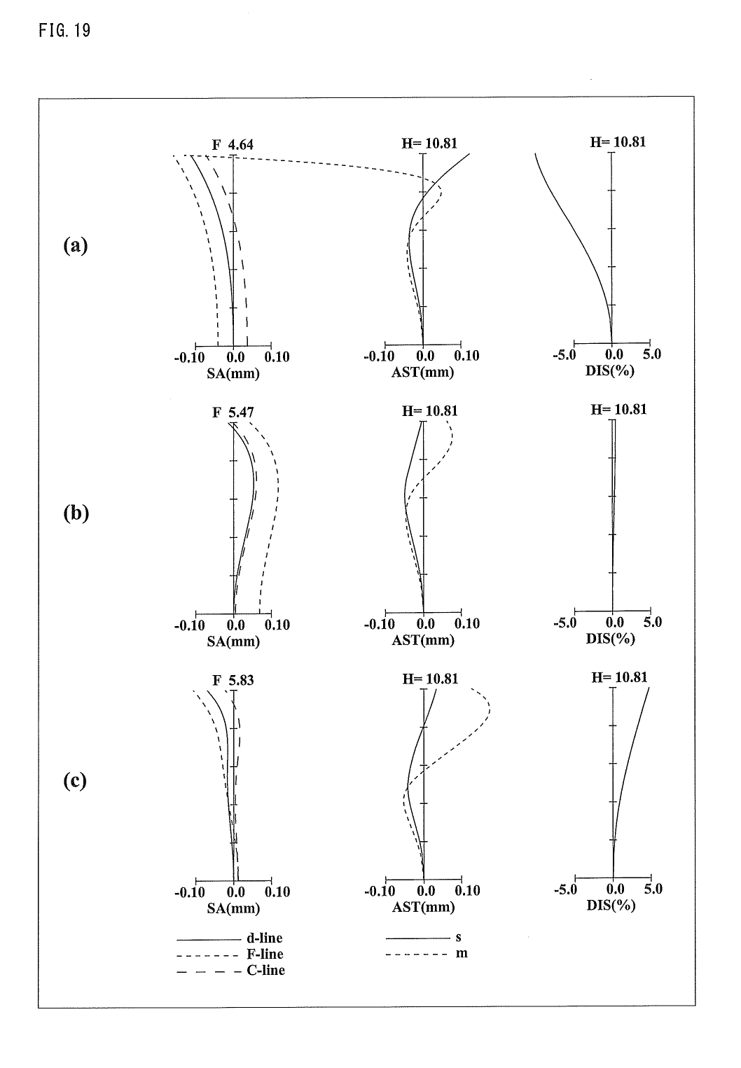

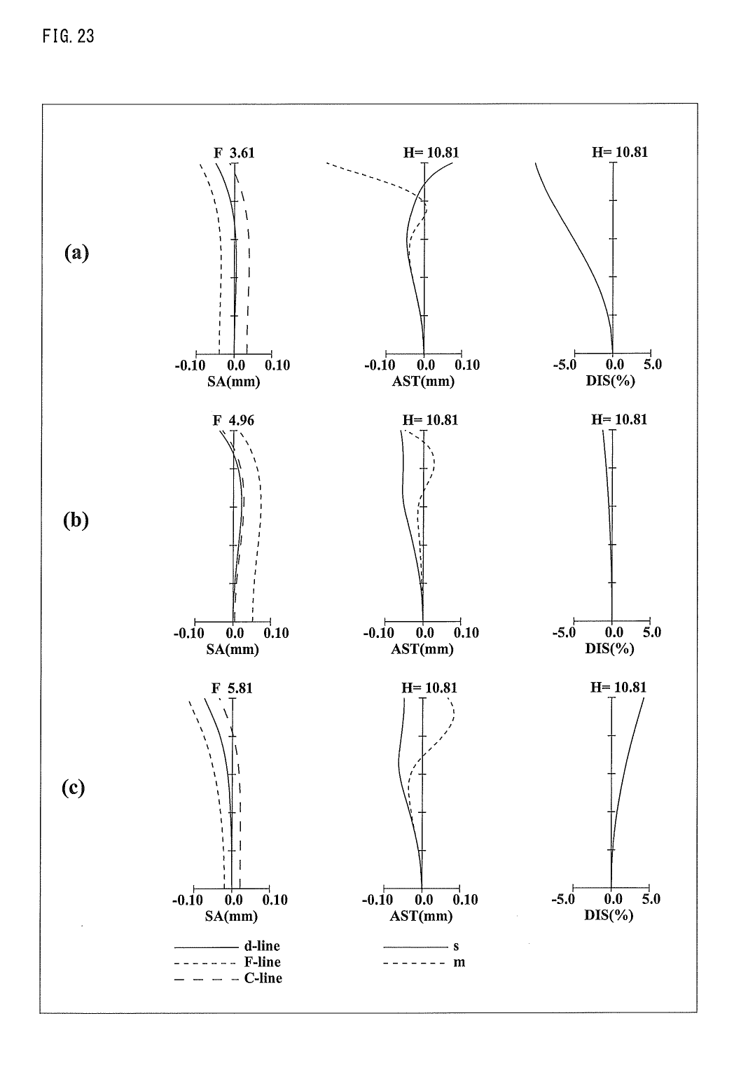

FIGS. 3, 7, 11, 15, 19, and 23 are longitudinal aberration diagrams of a close-object in-focus condition of the zoom lens systems according to Examples 1 to 6, respectively. The object distance in each example is as follows.

### Example 1 903 mm

### Example 2 903 mm

### Example 3 903 mm

### Example 4 903 mm

### Example 5 901 mm

### Example 6 909 mm

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

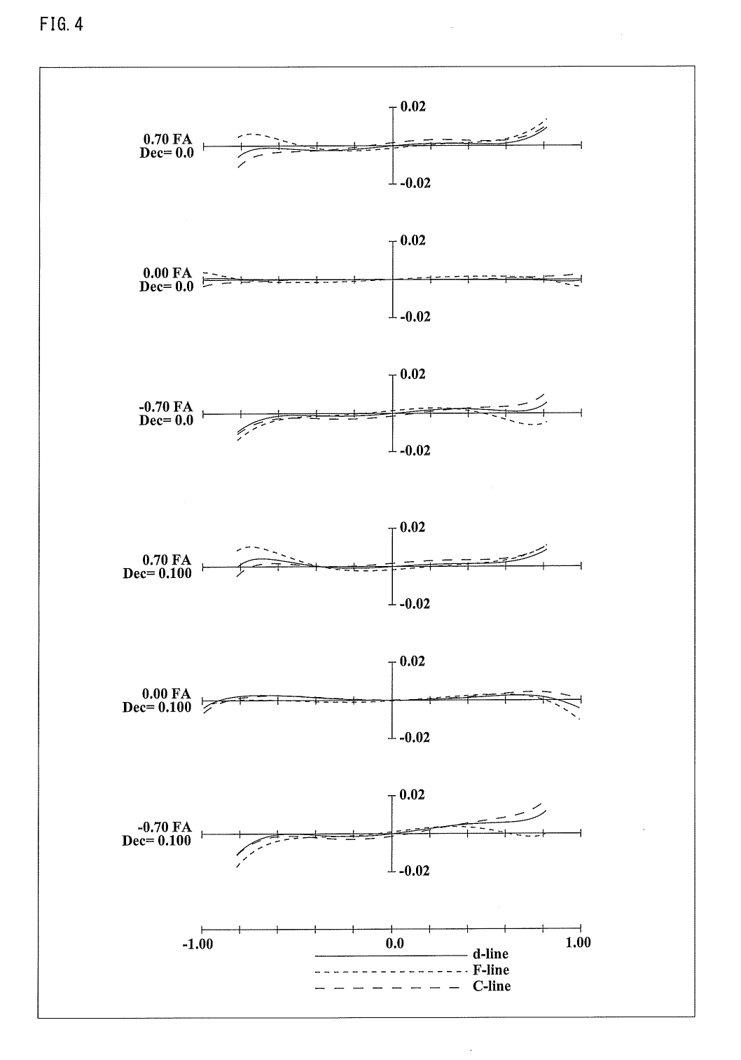

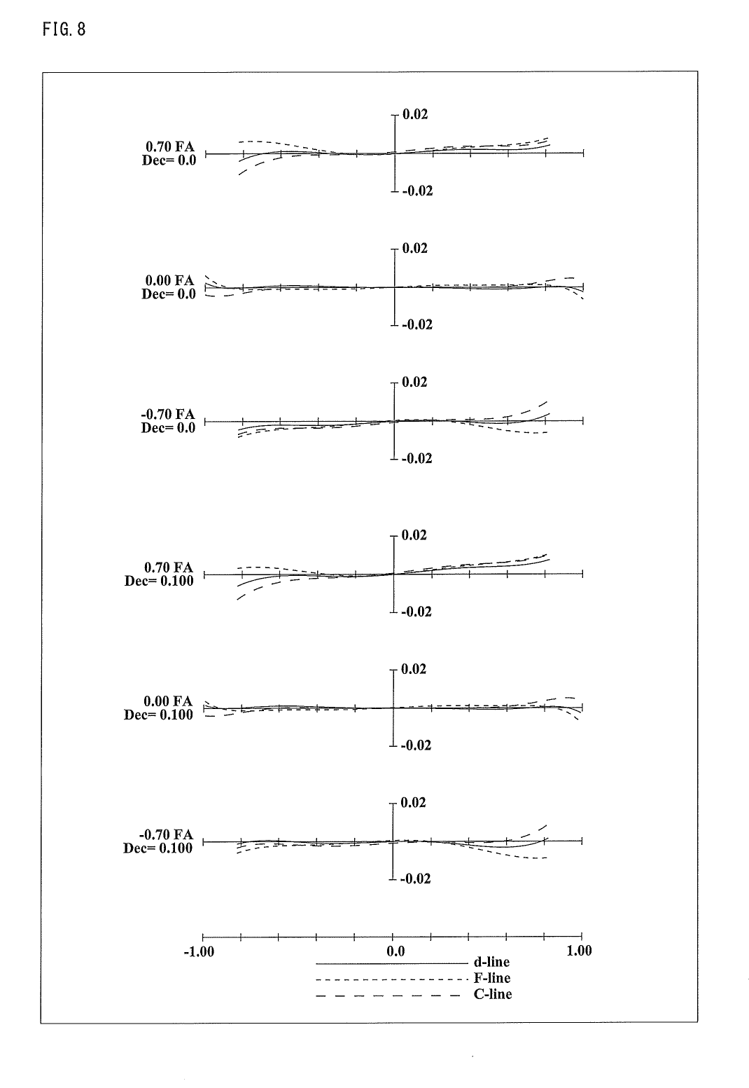

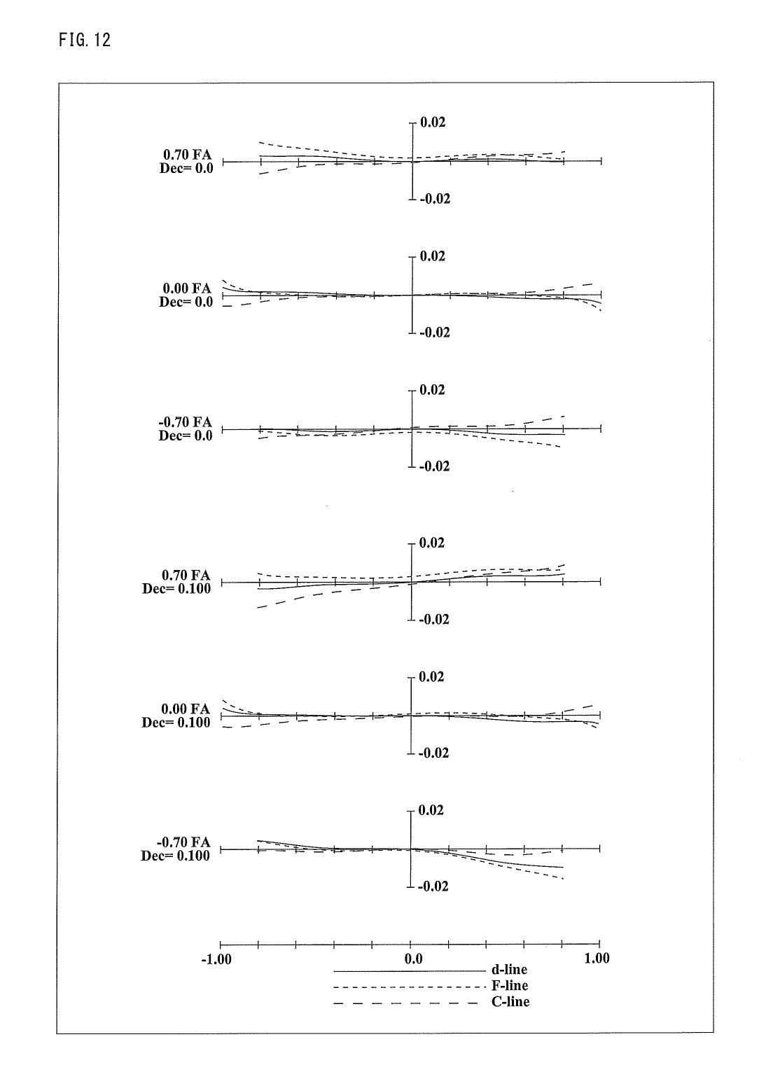

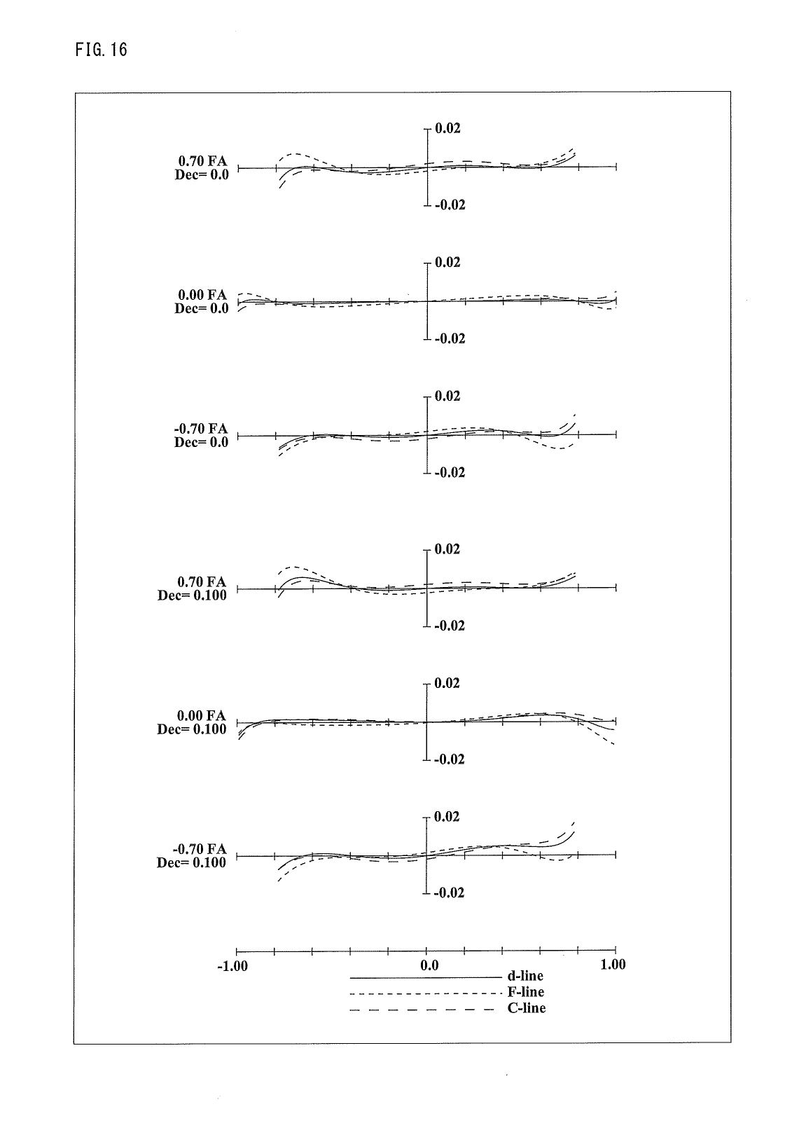

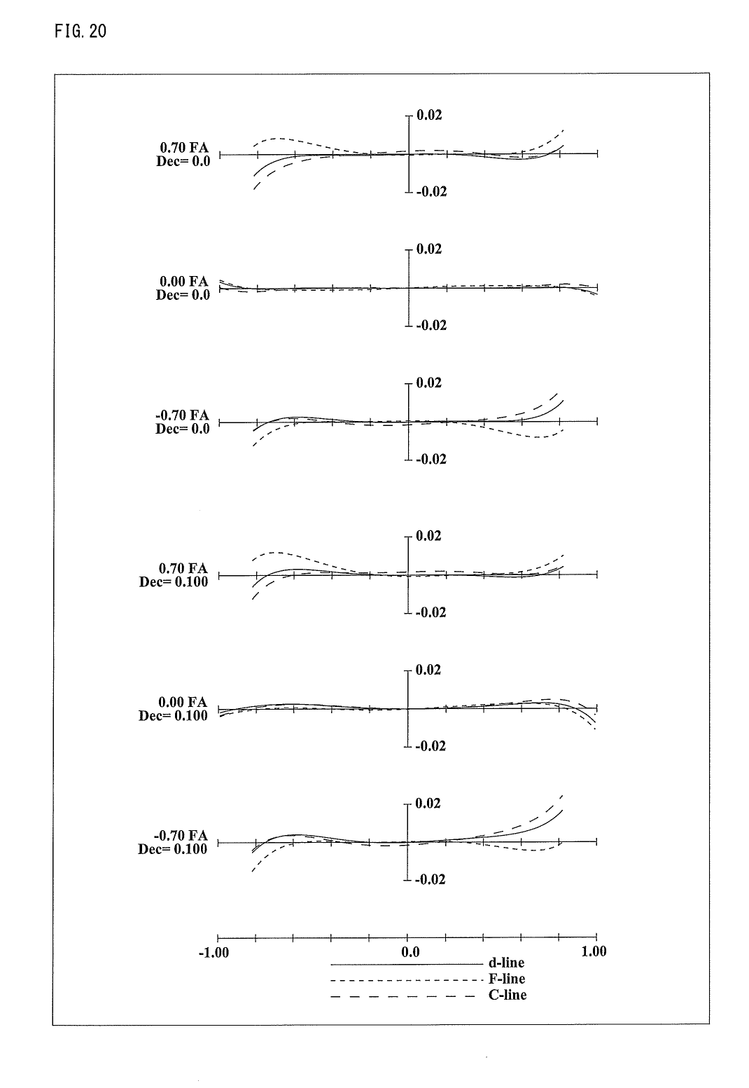

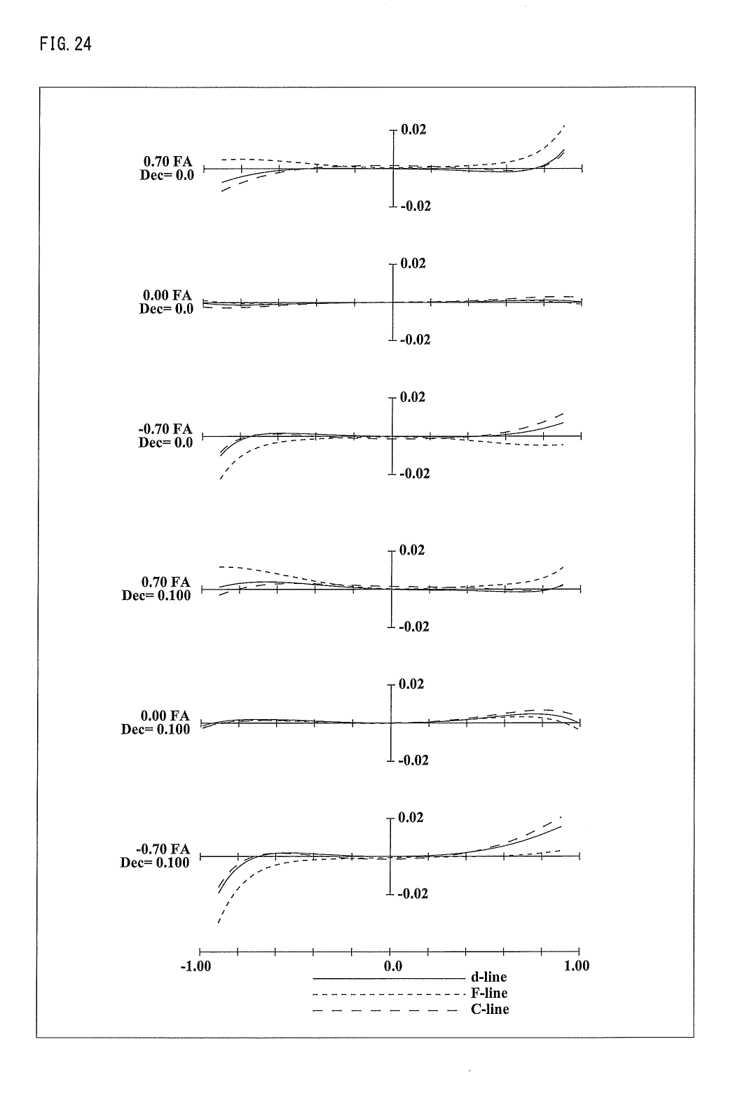

FIGS. 4, 8, 12, 16, 20, and 24 are lateral aberration diagrams of the zoom lens systems at a telephoto limit according to Examples 1 to 6, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the image blur compensating lens unit (Examples 1 to 4: the sixth lens element L6 and the seventh lens element L7 in the third lens unit G3, Examples 5 and 6: the seventh lens element L7 and the eighth lens element L8 in the third lens unit G3) is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line and the long dash line indicate the characteristics to the d-line, the F-line and the C-line, respectively. In each lateral aberration diagram, the meridional plane is adopted as the plane containing the optical axis of the first lens unit G1 and the optical axis of the third lens unit G3.

In the zoom lens system according to each example, the amount of movement of the image blur compensating lens unit in a direction perpendicular to the optical axis in the image blur compensation state at a telephoto limit is 0.1 mm.

When the shooting distance is infinity, at a telephoto limit, the amount of image decentering in a case that the zoom lens system inclines by a prescribed angle is equal to the amount of image decentering in a case that the image blur compensating lens unit displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to the prescribed angle without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows various data in an infinity in-focus condition. Table 4 shows various data in a close-object in-focus condition.

TABLE 1
(Surface data)

| Surface number | r | d | nd | vd |
|---|---|---|---|---|
| Object surface | ∞ | | | |
| 1* | −51.33730 | 2.00000 | 1.77200 | 50.0 |
| 2 | 22.35140 | 4.42510 | | |
| 3 | 34.80860 | 1.82320 | 1.94595 | 18.0 |
| 4 | 62.33670 | Variable | | |
| 5* | 20.01050 | 3.32360 | 1.77200 | 50.0 |
| 6* | −132.49120 | 0.15000 | | |
| 7 | 24.19920 | 2.24090 | 1.51680 | 64.2 |
| 8 | 55.68040 | 0.70000 | 1.71736 | 29.5 |
| 9 | 15.53300 | 2.72240 | | |
| 10(Diaphragm) | ∞ | Variable | | |
| 11 | 24.84220 | 0.70000 | 1.56732 | 42.8 |
| 12 | 10.35260 | 4.48740 | 1.49700 | 81.6 |
| 13 | −44.77720 | Variable | | |
| 14 | 75.63200 | 1.25930 | 1.48749 | 70.4 |
| 15 | 26.06800 | 0.60000 | 1.74330 | 49.2 |
| 16 | 13.27100 | Variable | | |
| 17 | −170.13430 | 4.70110 | 1.66910 | 55.4 |
| 18* | −21.52480 | (BF) | | |
| Image surface | ∞ | | | |

TABLE 2
(Aspherical data)

Surface No. 1
K = 0.00000E+00, A4 = 1.44046E−05, A6 = −9.96937E−09
Surface No. 5
K = 0.00000E+00, A4 = −1.28995E−05, A6 = 4.35997E−08
Surface No. 6
K = 0.00000E+00, A4 = 1.15565E−05, A6 = 3.60665E−08
Surface No. 18
K = 0.00000E+00, A4 = 1.72541E−05, A6 = 6.71641E−10

TABLE 3
(Various data in an infinity in-focus condition)
Zooming ratio 4.70873

| | Wide-angle | Middle | Telephoto |
|---|---|---|---|
| | limit | position | limit |
| Focal length | 14.4199 | 31.2702 | 67.8996 |
| F-number | 4.63506 | 5.45123 | 5.76842 |
| View angle | 40.1382 | 18.9768 | 8.8047 |
| Image height | 10.8150 | 10.8150 | 10.8150 |
| Overall length | 97.1300 | 97.1300 | 97.1300 |
| of lens system | | | |
| BF | 14.9500 | 14.9500 | 14.9500 |
| d4 | 41.2095 | 18.8556 | 0.6000 |
| d10 | 3.1583 | 3.3433 | 2.1000 |
| d13 | 3.2281 | 5.4065 | 18.0536 |
| d16 | 5.4466 | 25.4371 | 32.2891 |

Zoom lens unit data

| Lens | Initial | Focal |
|---|---|---|
| unit | surface No. | length |
| 1 | 1 | −28.14593 |
| 2 | 5 | 33.67634 |
| 3 | 11 | 37.64566 |
| 4 | 14 | −25.51925 |
| 5 | 17 | 36.36832 |

TABLE 4
(Various data in a close-object in-focus condition)
Zooming ratio 4.95655

| | Wide-angle | Middle | Telephoto |
|---|---|---|---|
| | limit | position | limit |
| Object distance | 902.8743 | 902.8743 | 902.8743 |
| Focal length | 14.3758 | 31.4658 | 71.2544 |
| F-number | 4.64446 | 5.48120 | 5.85347 |
| View angle | 39.9093 | 18.8267 | 8.6436 |
| Image height | 10.8150 | 10.8150 | 10.8150 |
| Overall length | 97.1300 | 97.1300 | 97.1300 |
| of lens system | | | |
| BF | 14.9500 | 14.9500 | 14.9500 |
| d4 | 41.2095 | 18.8556 | 0.6000 |
| d10 | 3.1583 | 3.3433 | 2.1000 |
| d13 | 3.3786 | 5.7638 | 19.4889 |
| d16 | 5.2961 | 25.0798 | 30.8538 |

Zoom lens unit data

| Lens | Initial | Focal |
|---|---|---|
| unit | surface No. | length |
| 1 | 1 | −28.14593 |
| 2 | 5 | 33.67634 |
| 3 | 11 | 37.64566 |
| 4 | 14 | −25.51925 |
| 5 | 17 | 36.36832 |

### Numerical Example 2

The zoom lens system of Numerical Example 2 corresponds to Embodiment 2 shown in FIG. 5. Table 5 shows the surface data of the zoom lens system of Numerical Example 2. Table 6 shows the aspherical data. Table 7 shows various data in an infinity in-focus condition. Table 8 shows various data in a close-object in-focus condition.

TABLE 5
(Surface data)

| Surface number | r | d | nd | vd |
|---|---|---|---|---|
| Object surface | ∞ | | | |
| 1* | −47.45190 | 2.00000 | 1.77200 | 50.0 |
| 2 | 25.08120 | 3.81610 | | |
| 3 | 39.02610 | 1.78090 | 1.94595 | 18.0 |
| 4 | 75.65090 | Variable | | |
| 5* | 20.19470 | 3.26680 | 1.77200 | 50.0 |
| 6* | −331.78530 | 0.15000 | | |
| 7 | 17.85360 | 2.68150 | 1.51680 | 64.2 |
| 8 | 44.47780 | 0.70000 | 1.71736 | 29.5 |
| 9 | 13.24670 | 3.08790 | | |
| 10(Diaphragm) | ∞ | Variable | | |
| 11 | 21.57550 | 0.70000 | 1.56732 | 42.8 |
| 12 | 11.43150 | 4.11940 | 1.49710 | 81.6 |
| 13* | −65.16140 | Variable | | |
| 14 | 90.18670 | 1.14860 | 1.48749 | 70.4 |
| 15 | 21.85880 | 0.60000 | 1.74330 | 49.2 |
| 16 | 13.26360 | Variable | | |
| 17 | −142.74220 | 4.52460 | 1.66910 | 55.4 |
| 18* | −21.72180 | (BF) | | |
| Image surface | ∞ | | | |

TABLE 6
(Aspherical data)

Surface No. 1
K = 0.00000E+00, A4 = 1.23371E−05, A6 = −7.37788E−09
Surface No. 5
K = 0.0000E+00, A4 = −9.97064E−06, A6 = 1.90173E−08
Surface No. 6
K = 0.0000E+00, A4 = 6.96696E−06, A6 = 2.04222E−08
Surface No. 13
K = 0.0000E+00, A4 = 8.96452E−06, A6 = −2.63466E−08
Surface No. 18
K = 0.0000E+00, A4 = 1.53055E−05, A6 = −6.79516E−10

TABLE 7
(Various data in an infinity in-focus condition)
Zooming ratio 4.70875

| | Wide-angle | Middle | Telephoto |
|---|---|---|---|
| | limit | position | limit |
| Focal length | 15.4499 | 33.4953 | 72.7500 |
| F-number | 4.63599 | 5.45165 | 5.76801 |
| View angle | 38.2334 | 17.8531 | 8.2779 |
| Image height | 10.8150 | 10.8150 | 10.8150 |
| Overall length | 96.9700 | 96.9700 | 96.9700 |
| of lens system | | | |
| BF | 14.9500 | 14.9500 | 14.9500 |
| d4 | 41.4420 | 18.9647 | 0.6000 |
| d10 | 3.1941 | 3.7135 | 2.1000 |
| d13 | 3.2789 | 5.4975 | 18.5732 |
| d16 | 5.5299 | 25.2693 | 32.1719 |

Zoom lens unit data

| Lens | Initial | Focal |
|---|---|---|
| unit | surface No. | length |
| 1 | 1 | −29.63510 |
| 2 | 5 | 34.80791 |
| 3 | 11 | 36.57774 |
| 4 | 14 | −26.02927 |
| 5 | 17 | 37.72598 |

TABLE 8
(Various data in a close-object in-focus condition)
Zooming ratio 4.95488

| | Wide-angle | Middle | Telephoto |
|---|---|---|---|
| | limit | position | limit |
| Object distance | 903.0292 | 903.0292 | 903.0292 |
| Focal length | 15.3935 | 33.6855 | 76.2729 |
| F-number | 4.64675 | 5.48483 | 5.86324 |
| View angle | 37.9799 | 17.6950 | 8.1075 |
| Image height | 10.8150 | 10.8150 | 10.8150 |
| Overall length | 96.9700 | 96.9700 | 96.9700 |
| of lens system | | | |
| BF | 14.95023 | 14.95017 | 14.94936 |
| d4 | 41.4420 | 18.9647 | 0.6000 |
| d10 | 3.1941 | 3.7135 | 2.1000 |
| d13 | 3.4522 | 5.9090 | 20.2265 |
| d16 | 5.3566 | 24.8578 | 30.5186 |

Zoom lens unit data

| Lens | Initial | Focal |
|---|---|---|
| unit | surface No. | length |
| 1 | 1 | −29.63510 |
| 2 | 5 | 34.80791 |
| 3 | 11 | 36.57774 |
| 4 | 14 | −26.02927 |
| 5 | 17 | 37.72598 |

### Numerical Example 3

The zoom lens system of Numerical Example 3 corresponds to Embodiment 3 shown in FIG. 9. Table 9 shows the surface data of the zoom lens system of Numerical Example 3. Table 10 shows the aspherical data. Table 11 shows various data in an infinity in-focus condition. Table 12 shows various data in a close-object in-focus condition.

TABLE 9
(Surface data)

| Surface number | r | d | nd | vd |
|---|---|---|---|---|
| Object surface | ∞ | | | |
| 1* | −43.97750 | 2.00000 | 1.77200 | 50.0 |
| 2 | 27.96920 | 3.43390 | | |
| 3 | 42.14800 | 1.73320 | 1.94595 | 18.0 |
| 4 | 85.81690 | Variable | | |
| 5* | 20.93850 | 3.43710 | 1.77200 | 50.0 |
| 6* | −220.66480 | 0.15000 | | |
| 7 | 15.30030 | 3.40110 | 1.51680 | 64.2 |
| 8 | 68.54170 | 0.70000 | 1.71736 | 29.5 |
| 9 | 11.97870 | 3.34560 | | |
| 10(Diaphragm) | ∞ | Variable | | |
| 11 | 22.78110 | 0.70000 | 1.56732 | 42.8 |
| 12 | 16.98570 | 3.15850 | 1.49710 | 81.6 |
| 13* | −116.22840 | Variable | | |
| 14 | 76.23900 | 1.17290 | 1.48749 | 70.4 |
| 15 | 22.40710 | 0.60000 | 1.74330 | 49.2 |
| 16 | 13.72940 | Variable | | |
| 17 | −123.60960 | 4.43220 | 1.66910 | 55.4 |
| 18* | −21.37710 | (BF) | | |
| Image surface | ∞ | | | |

TABLE 10
(Aspherical data)

Surface No. 1
K = 0.00000E+00, A4 = 1.06888E−05, A6 = −5.42122E−09
Surface No. 5
K = 0.00000E+00, A4 = −6.61708E−06, A6 = 8.71484E−09
Surface No. 6
K = 0.00000E+00, A4 = 7.39933E−06, A6 = 7.39617E−09
Surface No. 13
K = 0.00000E+00, A4 = 1.16953E−05, A6 = −2.93706E−08
Surface No. 18
K = 0.00000E+00, A4 = 1.48237E−05, A6 = −2.60419E−09

TABLE 11
(Various data in an infinity in-focus condition)
Zooming ratio 4.70870

| | Wide-angle | Middle | Telephoto |
|---|---|---|---|
| | limit | position | limit |
| Focal length | 16.4800 | 35.7509 | 77.5991 |
| F-number | 4.63533 | 5.45116 | 5.76878 |
| View angle | 36.4805 | 16.7631 | 7.7369 |
| Image height | 10.8150 | 10.8150 | 10.8150 |
| Overall length | 96.8400 | 96.8400 | 96.8400 |
| of lens system | | | |
| BF | 14.9500 | 14.9500 | 14.9500 |
| d4 | 41.4568 | 18.7448 | 0.6000 |
| d10 | 3.2910 | 5.1648 | 2.1000 |
| d13 | 3.2411 | 6.1152 | 22.1102 |
| d16 | 5.6403 | 23.6045 | 28.8192 |

Zoom lens unit data

| Lens | Initial | Focal |
|---|---|---|
| unit | surface No. | length |
| 1 | 1 | −30.81367 |
| 2 | 5 | 33.74943 |
| 3 | 11 | 40.23052 |
| 4 | 14 | −27.94674 |
| 5 | 17 | 37.97000 |

TABLE 12
(Various data in a close-object in-focus condition)
Zooming ratio 4.92198

| | Wide-angle | Middle | Telephoto |
|---|---|---|---|
| | limit | position | limit |
| Object distance | 903.1564 | 903.1564 | 903.1564 |
| Focal length | 16.4141 | 35.9361 | 80.7900 |
| F-number | 4.64866 | 5.48758 | 5.86490 |
| View angle | 36.1912 | 16.5914 | 7.5517 |
| Image height | 10.8150 | 10.8150 | 10.8150 |
| Overall length | 96.8400 | 96.8400 | 96.8400 |
| of lens system | | | |
| BF | 14.9500 | 14.9500 | 14.9500 |
| d4 | 41.4568 | 18.7448 | 0.6000 |
| d10 | 3.2910 | 5.1648 | 2.1000 |
| d13 | 3.4576 | 6.6608 | 24.4094 |
| d16 | 5.4238 | 23.0589 | 26.5200 |

Zoom lens unit data

| Lens | Initial | Focal |
|---|---|---|
| unit | surface No. | length |
| 1 | 1 | −30.81367 |
| 2 | 5 | 33.74943 |
| 3 | 11 | 40.23052 |
| 4 | 14 | −27.94674 |
| 5 | 17 | 37.97000 |

### Numerical Example 4

The zoom lens system of Numerical Example 4 corresponds to Embodiment 4 shown in FIG. 13. Table 13 shows the surface data of the zoom lens system of Numerical Example 4. Table 14 shows the aspherical data. Table 15 shows various data in an infinity in-focus condition. Table 16 shows various data in a close-object in-focus condition.

TABLE 13
(Surface data)

| Surface number | r | d | nd | vd |
|---|---|---|---|---|
| Object surface | ∞ | | | |
| 1* | −55.94830 | 2.00000 | 1.77200 | 50.0 |
| 2 | 20.49660 | 4.94100 | | |
| 3 | 31.41660 | 1.93950 | 1.94595 | 18.0 |
| 4 | 52.49320 | Variable | | |
| 5* | 19.51590 | 3.15320 | 1.77200 | 50.0 |
| 6* | −153.93410 | 0.85310 | | |
| 7 | 27.07210 | 2.04580 | 1.51680 | 64.2 |
| 8 | 56.94630 | 0.70000 | 1.71736 | 29.5 |
| 9 | 15.55800 | 2.56080 | | |
| 10(Diaphragm) | ∞ | Variable | | |
| 11 | 24.17360 | 0.70000 | 1.56732 | 42.8 |
| 12 | 10.00120 | 4.41980 | 1.49700 | 81.6 |
| 13 | −40.75830 | Variable | | |
| 14 | 55.97460 | 1.30390 | 1.48749 | 70.4 |
| 15 | 26.05830 | 0.60000 | 1.74330 | 49.2 |
| 16 | 13.38220 | Variable | | |
| 17 | −160.16440 | 4.77890 | 1.66910 | 55.4 |
| 18* | −20.97840 | (BF) | | |
| Image surface | ∞ | | | |

TABLE 14
(Aspherical data)

Surface No. 1
K = 0.00000E+00, A4 = 1.60141E−05, A6 = −1.09137E−08
Surface No. 5
K = 0.00000E+00, A4 = −1.35239E−05, A6 = 7.71764E−08
Surface No. 6
K = 0.00000E+00, A4 = 1.20778E−05, A6 = 6.94368E−08
Surface No. 18
K = 0.00000E+00, A4 = 1.79164E−05, A6 = 3.40746E−09

TABLE 15
(Various data in an infinity in-focus condition)
Zooming ratio 4.70869

| | Wide-angle | Middle | Telephoto |
|---|---|---|---|
| | limit | position | limit |
| Focal length | 13.3901 | 29.0376 | 63.0496 |
| F-number | 4.63571 | 5.45182 | 5.76820 |
| View angle | 42.1684 | 20.4069 | 9.4434 |
| Image height | 10.8150 | 10.8150 | 10.8150 |
| Overall length | 97.2400 | 97.2400 | 97.2400 |
| of lens system | | | |
| BF | 14.9500 | 14.9500 | 14.9500 |
| d4 | 41.2724 | 18.8230 | 0.6000 |
| d10 | 2.7012 | 3.1874 | 2.1000 |
| d13 | 3.3154 | 5.5225 | 19.3585 |
| d16 | 5.0049 | 24.7611 | 30.2357 |

Zoom lens unit data

| Lens | Initial | Focal |
|---|---|---|
| unit | surface No. | length |
| 1 | 1 | −27.09337 |
| 2 | 5 | 35.73317 |
| 3 | 11 | 35.73676 |
| 4 | 14 | −27.53598 |
| 5 | 17 | 35.58915 |

TABLE 16
(Various data in a close-object in-focus condition)
Zooming ratio 4.92221

| | Wide-angle | Middle | Telephoto |
|---|---|---|---|
| | limit | position | limit |
| Object distance | 902.7598 | 902.7598 | 902.7598 |
| Focal length | 13.3560 | 29.2155 | 65.7411 |
| F-number | 4.64472 | 5.48007 | 5.84425 |
| View angle | 41.9531 | 20.2501 | 9.2770 |
| Image height | 10.8150 | 10.8150 | 10.8150 |
| Overall length | 97.2400 | 97.2400 | 97.2400 |
| of lens system | | | |
| BF | 14.9500 | 14.9500 | 14.9500 |
| d4 | 41.2724 | 18.8230 | 0.6000 |
| d10 | 2.7012 | 3.1874 | 2.1000 |
| d13 | 3.4648 | 5.8816 | 20.8543 |
| d16 | 4.8555 | 24.4020 | 28.7399 |

Zoom lens unit data

| Lens | Initial | Focal |
|---|---|---|
| unit | surface No. | length |
| 1 | 1 | −27.09337 |
| 2 | 5 | 35.73317 |
| 3 | 11 | 35.73676 |
| 4 | 14 | −27.53598 |
| 5 | 17 | 35.58915 |

### Numerical Example 5

The zoom lens system of Numerical Example 5 corresponds to Embodiment 5 shown in FIG. 17. Table 17 shows the surface data of the zoom lens system of Numerical Example 5. Table 18 shows the aspherical data. Table 19 shows various data in an infinity in-focus condition. Table 20 shows various data in a close-object in-focus condition.

TABLE 17
(Surface data)

| Surface number | r | d | nd | vd |
|---|---|---|---|---|
| Object surface | ∞ | | | |
| 1* | 500.00000 | 2.00000 | 1.77200 | 50.0 |
| 2 | 17.40860 | 6.52700 | | |
| 3 | −62.23120 | 1.60000 | 1.77200 | 50.0 |
| 4* | 1135.40850 | 0.15000 | | |
| 5 | 56.38200 | 1.91750 | 1.94595 | 18.0 |
| 6 | 282.67870 | Variable | | |
| 7* | 17.82710 | 3.37890 | 1.77200 | 50.0 |
| 8* | −79.11820 | 0.43790 | | |
| 9 | 45.83150 | 1.70440 | 1.51680 | 64.2 |
| 10 | 66.87760 | 0.70000 | 1.71736 | 29.5 |
| 11 | 15.73520 | 2.53410 | | |
| 12(Diaphragm) | ∞ | Variable | | |
| 13 | 25.46900 | 0.70000 | 1.56732 | 42.8 |
| 14 | 10.29850 | 4.38590 | 1.49700 | 81.6 |
| 15 | −39.12750 | Variable | | |
| 16 | 35.08100 | 1.60010 | 1.48749 | 70.4 |
| 17 | 52.95700 | 0.60000 | 1.74330 | 49.2 |
| 18 | 13.33940 | Variable | | |
| 19 | −359.54150 | 4.69750 | 1.66910 | 55.4 |
| 20* | −22.48830 | (BF) | | |
| Image surface | ∞ | | | |

TABLE 18
(Aspherical data)

Surface No. 1
K = 0.00000E+00, A4 = −4.44832E−07, A6 = 8.65389E−09
Surface No. 4
K = 0.00000E+00, A4 = −1.14816E−05, A6 = 4.52736E−09
Surface No. 7
K = 0.00000E+00, A4 = −2.15475E−05, A6 = 5.88912E−08
Surface No. 8
K = 0.00000E+00, A4 = 1.52766E−05, A6 = 4.32905E−08
Surface No. 20
K = 0.00000E+00, A4 = 1.50135E−05, A6 = −7.64494E−09

TABLE 19
(Various data in an infinity in-focus condition)
Zooming ratio 4.70875

| | Wide-angle | Middle | Telephoto |
|---|---|---|---|
| | limit | position | limit |
| Focal length | 12.3599 | 26.8091 | 58.1999 |
| F-number | 4.63557 | 5.45177 | 5.76853 |
| View angle | 44.3446 | 21.9429 | 10.1280 |
| Image height | 10.8150 | 10.8150 | 10.8150 |
| Overall length | 99.0000 | 99.0000 | 99.0000 |
| of lens system | | | |
| BF | 14.9500 | 14.9500 | 14.9500 |
| d6 | 39.7352 | 17.7648 | 0.6000 |
| d12 | 3.3461 | 4.4597 | 2.1000 |
| d15 | 3.2498 | 6.2729 | 22.1578 |
| d18 | 4.7854 | 22.6191 | 26.2588 |

Zoom lens unit data

| Lens | Initial | Focal |
|---|---|---|
| unit | surface No. | length |
| 1 | 1 | −24.03229 |
| 2 | 7 | 35.17114 |
| 3 | 13 | 36.34687 |
| 4 | 16 | −27.87303 |
| 5 | 19 | 35.65325 |

TABLE 20
(Various data in a close-object in-focus condition)
Zooming ratio 4.84093

| | Wide-angle | Middle | Telephoto |
|---|---|---|---|
| | limit | position | limit |
| Object distance | 901.0000 | 901.0000 | 901.0000 |
| Focal length | 12.3315 | 26.9130 | 59.6961 |
| F-number | 4.64278 | 5.47369 | 5.82583 |
| View angle | 44.1838 | 21.8065 | 9.9780 |
| Image height | 10.8150 | 10.8150 | 10.8150 |
| Overall length | 99.0000 | 99.0000 | 99.0000 |
| of lens system | | | |
| BF | 14.9500 | 14.9500 | 14.9500 |
| d6 | 39.7352 | 17.7648 | 0.6000 |
| d12 | 3.3461 | 4.4597 | 2.1000 |
| d15 | 3.3823 | 6.6096 | 23.6230 |
| d18 | 4.6529 | 22.2824 | 24.7936 |

Zoom lens unit data

| Lens | Initial | Focal |
|---|---|---|
| unit | surface No. | length |
| 1 | 1 | −24.03229 |
| 2 | 7 | 35.17114 |
| 3 | 13 | 36.34687 |
| 4 | 16 | −27.87303 |
| 5 | 19 | 35.65325 |

### Numerical Example 6

The zoom lens system of Numerical Example 6 corresponds to Embodiment 6 shown in FIG. 21. Table 21 shows the surface data of the zoom lens system of Numerical Example 6. Table 22 shows the aspherical data. Table 23 shows various data in an infinity in-focus condition. Table 24 shows various data in a close-object in-focus condition.

TABLE 21
(Surface data)

| Surface number | r | d | nd | vd |
|---|---|---|---|---|
| Object surface | ∞ | | | |
| 1* | 500.00000 | 1.70000 | 1.77200 | 50.0 |
| 2 | 15.47200 | 5.98580 | | |
| 3 | −117.48690 | 1.50000 | 1.77200 | 50.0 |
| 4* | 136.13070 | 1.06250 | | |
| 5 | 40.50830 | 1.54040 | 1.94595 | 18.0 |
| 6 | 85.60550 | Variable | | |
| 7* | 17.04280 | 3.02590 | 1.77200 | 50.0 |
| 8* | −59.83160 | 0.15000 | | |
| 9 | 97.60080 | 1.43450 | 1.51680 | 64.2 |
| 10 | 57.03530 | 0.70000 | 1.71736 | 29.5 |
| 11 | 16.96520 | 2.13730 | | |
| 12(Diaphragm) | ∞ | Variable | | |
| 13 | 27.47780 | 0.70000 | 1.56732 | 42.8 |
| 14 | 9.82140 | 4.08740 | 1.49700 | 81.6 |
| 15 | −31.27500 | Variable | | |
| 16 | 28.11580 | 2.38600 | 1.48749 | 70.4 |
| 17 | −29.81070 | 0.60000 | 1.74330 | 49.2 |
| 18 | 14.67120 | Variable | | |
| 19 | 66.98870 | 5.00760 | 1.66910 | 55.4 |
| 20* | −31.32210 | (BF) | | |
| Image surface | ∞ | | | |

TABLE 22
(Aspherical data)

Surface No. 1
K = 0.00000E+00, A4 = 6.62618E−06, A6 = 2.03503E−09
Surface No. 4
K = 0.00000E+00, A4 = −9.40141E−06, A6 = −3.03110E−09
Surface No. 7
K = 0.00000E+00, A4 = −2.56970E−05, A6 = 3.97101E−08
Surface No. 8
K = 0.00000E+00, A4 = 1.90474E−05, A6 = 2.35038E−08
Surface No. 20
K = 0.00000E+00, A4 = 5.77048E−06, A6 = −9.76961E−09

TABLE 23
(Various data in an infinity in-focus condition)
Zooming ratio 3.92396

| | Wide-angle | Middle | Telephoto |
|---|---|---|---|
| | limit | position | limit |
| Focal length | 12.3600 | 24.4807 | 48.5000 |
| F-number | 3.60549 | 4.94409 | 5.76811 |
| View angle | 44.3597 | 24.1687 | 12.1454 |
| Image height | 10.8150 | 10.8150 | 10.8150 |
| Overall length | 91.0000 | 91.0000 | 91.0000 |
| of lens system | | | |
| BF | 14.9500 | 14.9500 | 14.9500 |
| d6 | 31.8858 | 14.1861 | 0.6000 |
| d12 | 5.7214 | 4.7214 | 2.1000 |
| d15 | 3.1000 | 7.4755 | 22.1554 |
| d18 | 3.3253 | 17.6494 | 19.1771 |

Zoom lens unit data

| Lens | Initial | Focal |
|---|---|---|
| unit | surface No. | length |
| 1 | 1 | −21.13358 |
| 2 | 7 | 33.33129 |
| 3 | 13 | 34.83229 |
| 4 | 16 | −24.93655 |
| 5 | 19 | 32.56285 |

TABLE 24
(Various data in a close-object in-focus condition)
Zooming ratio 3.96677

| | Wide-angle | Middle | Telephoto |
|---|---|---|---|
| | limit | position | limit |
| Object distance | 909.0000 | 909.0000 | 909.0000 |
| Focal length | 12.3275 | 24.5204 | 48.9004 |
| F-number | 3.61020 | 4.96156 | 5.81472 |
| View angle | 44.2353 | 24.0369 | 12.0001 |
| Image height | 10.8150 | 10.8150 | 10.8150 |
| Overall length | 91.0000 | 91.0000 | 91.0000 |
| of lens system | | | |
| BF | 14.9500 | 14.9500 | 14.9500 |
| d6 | 31.8858 | 14.1861 | 0.6000 |
| d12 | 5.7214 | 4.7214 | 2.1000 |
| d15 | 3.2287 | 7.7867 | 23.3457 |
| d18 | 3.1966 | 17.3382 | 17.9868 |

Zoom lens unit data

| Lens | Initial | Focal |
|---|---|---|
| unit | surface No. | length |
| 1 | 1 | −21.13358 |
| 2 | 7 | 33.33129 |
| 3 | 13 | 34.83229 |
| 4 | 16 | −24.93655 |
| 5 | 19 | 32.56285 |

The following Table 25 shows the corresponding values to the individual conditions in the zoom lens systems of each of Numerical Examples.

TABLE 25
(Values corresponding to conditions)

| | | Example | | | | | |
|---|---|---|---|---|---|---|---|
| Condition | | 1 | 2 | 3 | 4 | 5 | 6 |
| (1) | fₙ/f_{w} | −1.770 | −1.685 | −1.696 | −2.056 | −2.255 | −2.018 |
| (2) | T₁/f_{w} | 0.572 | 0.492 | 0.435 | 0.663 | 0.987 | 0.954 |
| (3) | \|f₁/f_{w}\| | 1.952 | 1.918 | 1.870 | 2.023 | 1.944 | 1.710 |
| (4) | \|f₂/f_{w}\| | 2.335 | 2.253 | 2.048 | 2.669 | 2.846 | 2.697 |
| (5) | (T₁ + T₂)/ | 1.206 | 1.132 | 1.104 | 1.359 | 1.695 | 1.556 |
| | f_{w} | | | | | | |
| (6) | (T₁ + T₂)/ | 1.608 | 1.617 | 1.683 | 1.682 | 1.937 | 1.779 |
| | H | | | | | | |

The zoom lens system according to the present invention is applicable to a digital still camera, a digital video camera, a camera for a mobile telephone, a camera for a PDA (Personal Digital Assistance), a surveillance camera in a surveillance system, a Web camera, a vehicle-mounted camera or the like. In particular, the zoom lens system according to the present invention is suitable for a photographing optical system where high image quality is required like in a digital still camera system or a digital video camera system.

Also, the zoom lens system according to the present invention is applicable to, among the interchangeable lens apparatuses according to the present invention, an interchangeable lens apparatus having motorized zoom function, i.e., activating function for the zoom lens system by a motor, with which a digital video camera system is provided.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. A zoom lens system comprising a plurality of lens units, each lens unit comprising at least one lens element, wherein
a lens unit located closest to an object side has negative optical power,
in zooming from a wide-angle limit to a telephoto limit at the time of image taking, the lens unit located closest to the object side and a lens unit located closest to an image side are fixed relative to an image surface,
the lens unit located closest to the object side includes at least one lens element having positive optical power and at least one lens element having negative optical power, and
an image blur compensating lens unit is provided, which moves in a direction perpendicular to an optical axis, in order to optically compensate image blur.

2. The zoom lens system as claimed in claim 1, wherein among lens units located on the image side relative to an aperture diaphragm, a lens unit having negative optical power is a focusing lens unit which moves along the optical axis in focusing from an infinity in-focus condition to a close-object in-focus condition, on at least one zooming position from a wide-angle limit to a telephoto limit.

3. The zoom lens system as claimed in claim 1, wherein the image blur compensating lens unit has positive optical power.

4. The zoom lens system as claimed in claim 2, wherein the image blur compensating lens unit and the focusing lens unit are arranged adjacent to each other.

5. The zoom lens system as claimed in claim 2, wherein a lens unit having positive optical power is provided on each of the object side and the image side of the focusing lens unit.

6. The zoom lens system as claimed in claim 1, wherein the following condition (2) is satisfied:
0.1<T₁/f_{W}<1.5 (2)
where
T₁ is an axial thickness of the lens unit located closest to the object side, and
f_{W} is a focal length of the entire system at a wide-angle limit.

7. The zoom lens system as claimed in claim 1, wherein the following condition (5) is satisfied:
0.1<(T₁+T₂)/f_{W}<2.5 (5)
where
T₁ is an axial thickness of the lens unit located closest to the object side,
T₂ is an axial thickness of a lens unit located having one air space toward the image side from the lens unit located closest to the object side, and
f_{W} is a focal length of the entire system at a wide-angle limit.

8. An interchangeable lens apparatus comprising:
the zoom lens system as claimed in claim 1; and
a lens mount section which is connectable to a camera body including an image sensor for receiving an optical image formed by the zoom lens system and converting the optical image into an electric image signal.

9. A camera system comprising:
an interchangeable lens apparatus including the zoom lens system as claimed in claim 1; and
a camera body which is detachably connected to the interchangeable lens apparatus via a camera mount section, and includes an image sensor for receiving an optical image formed by the zoom lens system and converting the optical image into an electric image signal.
